(19) United States
(12) Patent Application Publication
(10) Pub. No.: US 2023/0189763 A1
(43) Pub. Date: Jun. 22, 2023

(54) Animal Wellness Monitoring Systems and Methods

(71) Applicant: AeXonis Holdings Inc., Irving, TX (US)

(72) Inventors: Gilles Alain Georges Blanc, Centennial, CO (US); Rémy André Jean Blanc, Dallas, TX (US); Patrick Louis Fiche, Palaiseau (FR); Idomeneas Chorafakis, Toronto (CA)

(21) Appl. No.: 18/112,845

(22) Filed: Feb. 22, 2023

Related U.S. Application Data
(63) Continuation-in-part of application No. 17/587,452, filed on Jan. 28, 2022.
(60) Provisional application No. 63/142,995, filed on Jan. 28, 2021.
(60) Provisional application No. 63/313,231, filed on Feb. 23, 2022.

(51) Int. Cl. A01K 29/00; A01K 11/00; G01S 13/87; G01S 7/02; G06K 7/00; G06K 19/07

(52) U.S. Cl. CPC A01K 29/005; A01K 11/006; A01K 11/004; G01S 13/878; G01S 7/023; G06K 7/0008; G06K 19/0723

(57) ABSTRACT

An animal management system for monitoring a plurality of animals over time includes a data management subsystem and a data acquisition subsystem, which includes RF asset tags. The data acquisition acquires data concerning the animals and efficiently provides it to aspects of the system for processing. The data may also include information from an environment data acquisition subsystem. The data management subsystem determines current wellness scores for each animal of a group of animals and a period wellness score for each animal over a larger period of time. Alerts may be sent went data shows an animal outside of threshold values. Other embodiments are presented.

### CROSS-REFERENCE TO RELATED APPLICATION

This application is a continuation in part of U.S. application Ser. No. 17/587,452, filed by Gilles Alain Georges Blanc, et al., on Jan. 28, 2022, entitled “Feedlot Ear-Tag Systems and Methods,” which claims the benefit of U.S. Provisional Application Ser. No. 63/142,995, filed by Gilles Alain Georges Blanc et al., on Jan. 28, 2021, entitled “Feedlot Ear-Tag Systems and Methods.” This application also claims the benefit of U.S. Provisional Application Ser. No. 63/313,231, filed by Gilles Alain Georges Blanc et al., on Feb. 23, 2022, entitled “Animal Wellness Monitoring Systems and Methods.” All these applications are incorporated herein by reference for all purposes.

### TECHNICAL FIELD

This disclosure is directed, in general, to systems and methods for monitoring of eating and drinking by livestock and, more specifically, to such systems and methods in a feedlot environment.

### BACKGROUND

The following discussion of the background is intended to facilitate an understanding of the present disclosure only. It should be appreciated that the discussion is not an acknowledgement or admission that any of the material referred to was part of the common general knowledge at the priority date of the application.

In many places, the final stage of processing livestock in large scale commercial operations takes place in feedlots, with the goal of increasing the body weight of animals before they are brought to market. In the feedlot stage, a mature group of animals is placed in a high-density and stressful environment, which significantly increases the potential for health complications. As such, special attention is given to animal health, activity, water intake and diet. Improvements in methods and devices for caring for the livestock are desired.

### SUMMARY

According to an illustrative embodiment, an animal management system for monitoring a plurality of animals over time includes an animal data acquisition subsystem. The data acquisition subsystem includes a plurality of RF asset tags attached to the plurality of animals. Each of the plurality of RF asset tags includes a non-volatile memory having a unique identifier code that can be transmitted when the RF asset tag is energized by a radio signal. The data acquisition subsystem further includes a plurality of RF detector stations. At least one member of the plurality of RF detector stations is positioned at least within 3 meters of at least one water trough, and at least one of the plurality of RF detector stations is positioned within 3 meters of at least one feed trough. The RF detector is configured to transmit a radio signal to any of the plurality of RF asset tags within a detection zone for that RF detector and receive a returned signal with the unique identifier code. Each of the plurality of RF detectors has a detector-station processor and a detector-station memory, which is a non-transitory memory, for executing programmed code. The data acquisition subsystem further includes a communication link for receiving transmitted signals from the plurality of RF detector stations and delivering the transmitted signal or data therefrom to a data management subsystem.

The data management subsystem includes a management processor and management memory. The management memory is a non-transitory memory. For each of the plurality RF detector stations, the detector-station processor and the detector-station memory include programming to receive a returned signal with the unique identifier code from any RF asset tags in its detection zone and transmit the unique identifier code using the communication link to the data management subsystem. The detector-station memory includes stored instructions, which when executed by the detector-station processor, cause the detector-station processor to only transmit detections of RF asset tag detections above a detection threshold for a given time period. Adjacent members of the plurality of RF detector stations communicate with one another and only send one signal with data over the communication link to the data management subsystem to save energy for one of the adjacent members. Each of the plurality of RF detector stations includes a synchronization clock and the plurality of RF detector stations are programmed to transmit at unique times to avoid interference.

The animal management system also includes an environment data acquisition subsystem. The environment data acquisition subsystem includes one or more sensors for detecting an attribute of an environment, and a transmitter coupled to the one or more sensors for transmitting data from the one or more sensors to the data management system. The data management system also includes a data-management-system processor and a data-management-system memory programmed to execute the following steps: store received data from the animal data acquisition subsystem and the environment data acquisition system in a database; determine and store a current wellness score for each animal or a group of animals from the received data; and using the current wellness score for a period of time to determine a period wellness score for each animal or a group of animals.

According to another illustrative embodiment, an animal management system for monitoring a plurality of animals over time includes a data management subsystem and an animal data acquisition subsystem. The animal data acquisition subsystem includes a plurality of RF asset tags attached to each animal of the plurality of animals and a plurality of RF detector stations for detecting a presence of members of the plurality of RF asset tags and receiving animal-specific identifiers. The plurality of RF detectors is at least in part positioned proximate to water troughs and feed troughs used by the plurality of animals. The animal data acquisition subsystem further includes one or more communication links for transmitting information from the plurality of RF detector stations to the data management system.

The animal management system may further include an environment data acquisition subsystem. The data acquisition subsystem includes one or more sensors for detecting an attribute of an environment and a transmitter for transmitting data from the one or more sensors to the data management system.

The data management subsystem includes a data management processor and a data management memory programmed to execute the following steps: store received data from the animal data acquisition subsystem and the environment data acquisition system in a database, determine and store a current wellness score for each animal or a group of animals from the received data, and use the current wellness scores to determine a period wellness score for each animal or a group of animals.

According to another illustrative embodiment, an animal management system for monitoring a plurality of animals includes an asset management subsystem and a plurality of RF asset tags attached to the plurality of animals. Each of the plurality of RF asset tags includes a non-volatile memory having a unique identifier code that is transmitted when the RF asset tag is energized by a radio signal. The animal management system also includes a plurality of RF detector stations. At least one of the plurality of RF detector stations is positioned at least within 3 meters of the at least one water trough and at least one of the plurality of RF detector stations is positioned within 3 meters of the at least one feed trough. In some embodiments, the stations may be within 10 meters of the troughs.

The animal management system also includes at least one environment sensor for measuring an environmental attribute in which the plurality of animals is located to produce environmental data and a means for transmitting the unique identifiers for detected members of the plurality of animals and the environmental data to the asset management subsystem. The asset management subsystem includes a management memory and a management processor. The management memory is a non-volatile member.

The management memory and management processor perform the following programmed steps: receiving and storing data from the plurality of RF detector stations, receiving and storing the environmental data, and using the environmental data and the data from the plurality of RF detector stations to produce a current wellness score indicative of a member of the plurality of animals' health or indicative of the plurality of animals' health.

### DESCRIPTION OF THE DRAWINGS

Illustrative embodiments of the present inventions are described in detail below with reference to the attached drawing figures, which are incorporated by reference herein and wherein:

FIG. 1 is a schematic diagram of an illustrative embodiment of a system for monitoring the activities of livestock in a feedlot or other setting;

FIG. 2 is a schematic diagram of an illustrative embodiment of an asset tag (or RFID tag or passive tag);

FIG. 3 is a schematic diagram of an illustrative embodiment of a detector station for detecting an asset tag;

FIG. 4A is a schematic diagram of a portion of an illustrative embodiment of a system for monitoring the activities of livestock in a feedlot or other setting;

FIG. 4B is a schematic diagram of a portion of an illustrative embodiment of a system for monitoring the activities of livestock in a feedlot or other setting showing an alternative tag that is a visible bar code;

FIG. 5 is a schematic diagram of a portion of an illustrative embodiment of a system for monitoring the activities of livestock in a feedlot or other setting showing overlapping coverage of detector stations;

FIG. 6 is a schematic diagram of a portion of an illustrative embodiment of a system for monitoring the activities of livestock in a feedlot or other setting showing overlapping coverage of detector stations and showing illustrative movement of an asset tag;

FIG. 7 is a schematic diagram of an illustrative embodiment of sensing records for two detector stations as an aspect of an illustrative embodiment of a system for monitoring the activities of livestock in a feedlot or other setting;

FIG. 8 is a schematic diagram of an illustrative embodiment of sensing records transmitted to a gateway;

FIG. 9 is a schematic diagram of a portion of an illustrative embodiment of a system for monitoring the activities of livestock in a feedlot or other setting showing aspects of a mesh network;

FIG. 10 is a schematic diagram presenting interaction between adjacent detector stations and a gateway according to one illustrative embodiment;

FIG. 11 is a schematic diagram of a feed or water trough of an illustrative embodiment of a system for monitoring the activities of livestock in a feedlot or other setting showing two adjacent detector stations;

FIG. 12 is a schematic diagram of a trough positioned in a cartesian plane or X-Y graph and showing movement of an asset tag towards the trough;

FIG. 13 is an illustrative process flow diagram of a process that may be used to identify movement of an asset tag by a detector station or other processor;

FIG. 14 is a schematic representation of a representative example of hardware components of a programmable computer that may be used for an asset management system or other aspect of a system for monitoring the activities or wellness of livestock in a feedlot or other setting;

FIG. 15 is a schematic diagram of an illustrative embodiment of a system for monitoring the activities of livestock and the conditions of the environment in large scale commercial operations or other settings;

FIG. 16 is a schematic diagram of an illustrative embodiment of a system for collecting and analyzing data collected and transmitted by a plurality of sensors and detectors;

FIG. 17 is a schematic diagram of an illustrative embodiment of a data management system for aggregating a plurality of wellness score values into a lifetime wellness score per animal;

FIG. 18 is a schematic diagram of an illustrative embodiment of a lifetime aggregator for determining a plurality of wellness sub-scores;

FIGS. 19A-D are schematic diagrams of illustrative embodiments of methods using different types of machine learning algorithms used to compute wellness sub-scores;

FIG. 20 is a schematic diagram of an illustrative embodiment of a portion of a data management system that uses a plurality of supervised machine learning models to determine wellness sub-scores;

FIG. 21 is a schematic diagram of an illustrative embodiment of a portion of a data management system that uses a plurality of unsupervised machine learning models to determine wellness sub-scores;

FIG. 22 is a schematic diagram of an illustrative embodiment of a portion of a data management system that uses a plurality of reinforcement machine learning models to determine wellness sub-scores;

FIG. 23 is a schematic diagram of an illustrative embodiment of a portion of a data management system that uses a data pre-processing correlation and normalizatoin module with reinforced learning;

FIG. 24 is a schematic diagram of an illustrative embodiment of a method that aggregates a plurality of current wellness sub-scores into a single current wellness score value;

FIG. 25 is a schematic diagram of an illustrative embodiment of a portion of a data management system that aggregates a time series of current wellness score values to determine a lifetime wellness score for an animal;

FIG. 26 is an illustrative process flow diagram that may be used for the data management system to prepare scores and provide alerts;

FIG. 27 is an illustrative process flow diagram of running analytics to determine group metrics and individual animal type sub-scores;

FIG. 28 is an illustrative process flow diagram for an aggregator to combine sub-scores into a single current score per animal; and

FIG. 29 is illustrative process flow diagram of an alert subsystem.

### DETAILED DESCRIPTION

In the following detailed description, reference is made to the accompanying drawings that form a part hereof, and in which is shown, by way of illustration, specific embodiments in which the invention may be practiced. These embodiments are described in sufficient detail to enable those skilled in the art to practice the inventions, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present inventions are defined only by the claims. Unless otherwise indicated, as used throughout this document, “or” does not require mutual exclusivity.

Livestock in large-scale, commercial feedlots are often grouped within a number of individual adjacent feedlots. Each feedlot includes food troughs, which are where the animals eat, and water troughs, which are where the animals drink. These may be entirely contained within a single feedlot enclosure or shared between adjacent feedlot enclosures. In one illustrative embodiment, a system for monitoring livestock in a feedlot includes using passive RF asset tags (or RFID tags) that are affixed to the livestock, e.g., cattle. Such passive RF asset tags do not require batteries, are light weight, easy to affix to the livestock, and are of low-cost construction. When a passive RF tag is scanned by a detector (or reader), the detector transmits energy to the tag and that powers it enough for the chip in the tag to relay information back to the detector.

Situated at the vicinity of the feed and water troughs are RF tag detectors. The detectors emit a localized RF signal which energize the passive RF tags, or cattle tags, within the immediate area of the detector (e.g., within a few meters). Signals from the energized RF asset tags of nearby livestock are recorded to track each cow's or other animal's position, movement in the vicinity of the detector, or other positioned-based data. A multiplicity of such detectors is applied to collectively track each animal's movement to determine where and when the animal eats or drinks, and for how long. This information is analyzed and communicated in an efficient manner by the detectors, and in a manner as to conserve detector battery energy in some embodiments, to a wireless gateway situated near the feedlots. The gateway sends the assimilated data from the detectors to a central server or data system for further processing and reporting.

In one illustrative embodiment, the systems and methods aim to provide a low-cost, easy-to-deploy system for the monitoring of cattle as the animals move through feedlots. Careful monitoring of the behavior of cattle while in the feedlot is important for the animals' wellbeing, as well as to assure efficient, cost saving operations in the preparation of the cattle for market.

In one illustrative embodiment, a system is provided that constitutes a departure from other systems that use wireless RF technology for active and passive tags that pertain to the monitoring of cattle in grazing fields of thousands of acres in area. Such situations require the use of cattle-mounted active tags containing batteries of sufficient capacity to power the tags' built-in radio transceivers, GPS, and other sensors that may be included in the tags. The batteries can be costly and may not be commercially desirable. Moreover, network coverage over large areas is likewise costly, and relies on satellite, cellular, or emerging long-range, low-power (e.g., LoRA) wireless services. By contrast, an illustrative system hereunder makes use of low-cost passive RF asset tags that do not require batteries. These tags typically cost below $5 per piece at the present time. Likewise, the close radio coverage of the detectors makes them low cost to manufacture and operate, even if battery powered.

Through the use of passive radio frequency RFID asset tags affixed to the livestock, e.g., cattle, and RF detector-relay assemblies situated at desired points within the feedlot or other space, the trajectory of each animal in the feedlot is passively tracked to ascertain the location and time that the animal eats, drinks, and engages in other behavior. The detector-relay assemblies also contain one or more processors, e.g., a microcomputer, to determine the cattle trajectories within the feedlot, and to reduce the amount of data transmitted to a central management system, thereby conserving spectral resources (to prevent signal collisions) and battery power of the detector-relays.

For the purposes of this disclosure, the term “cattle” refers, in general, to bovine livestock. An individual animal in a population of cattle may be referred to as an “animal” or “cow,” the latter term without regards to the sex of the animal. However, this disclosure is not restricted to cattle, but apply to other forms of livestock that make use of feedlots, including pigs, sheep, bison, and other animals sold to market as food. The systems and methods may be used to monitor various types of animals in other context or settings, e.g., in zoos, veterinary clinics, pet breeding, dog boarding, etc.

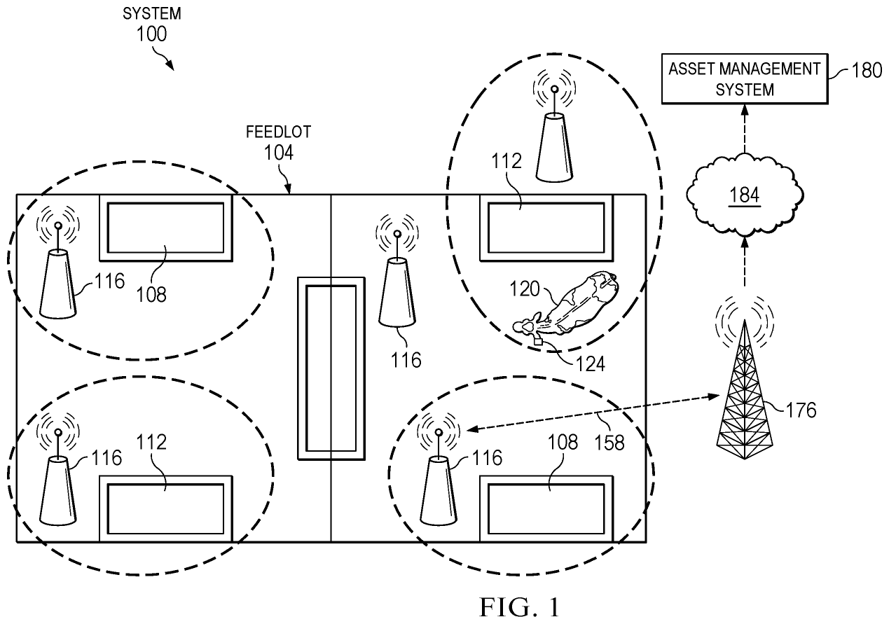

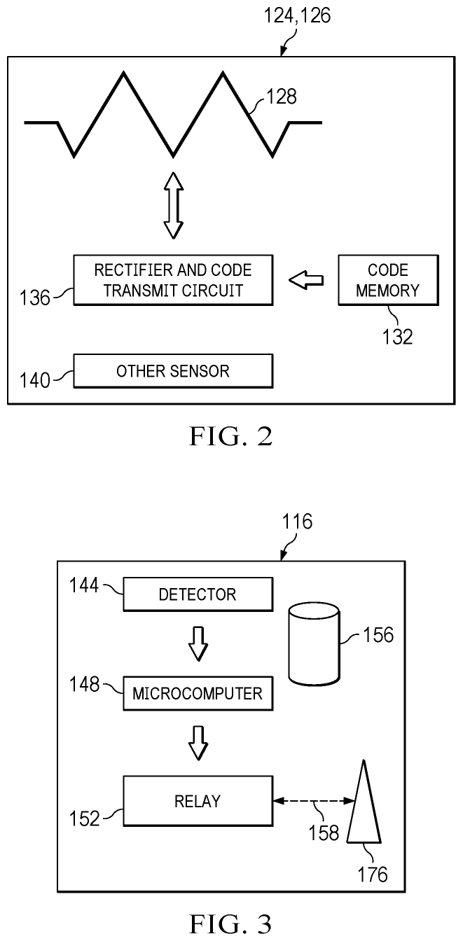

Referring now to the figures, and initially to FIG. 1, an illustrative embodiment of an overall system 100 is presented. The system 100 may be used with many animals and in many contexts as previously referenced, but is presented in this illustration within the feedlot stage of an overall cattle processing operation. A feedlot 104 is a confined area, accessible to the animal via gates, that contains a plurality of feed troughs 108, a plurality of water troughs 112, barriers, and other means to manage the preparation of cattle for market. Within each feedlot 104 are a plurality of detectors 116 or detector stations, typically mounted in the vicinity of each feed trough 108 and water trough 112. When an animal 120, e.g., a cow, approaches a trough 108 or 112, the nearby detector station 116 senses the presence of the animal's asset tag 124, e.g., passive RF tag 126 (FIG. 2) in its ear. The wireless sensing of the asset tag 124 is recorded by one or multiple nearby detector stations 116 and transmitted over a network 184 or other connectivity to a gateway 176 and on to an asset management system (or subsystem) 180, which includes a management processor and a management memory.

Referring now primarily to FIGS. 1 and 2, an illustrative asset tag 124 in the form of an “RFID” asset tag 126 or “RF tag” or “asset tag” is presented. The RFID tag 126 is a passive tag device that is typically mounted on the ear of the livestock, but may be mounted elsewhere, e.g., affixed to a collar or other device worn by the animal, or embedded within the body of the animal. By “passive” it is to be understood that the tag 126 contains no replaceable or rechargeable battery, and that the RF tag 126 is powered by a tuned radio wave that is emitted by a detector, e.g., detector station 116, nearby (within typically 10 meters) of the RF tag 126.

Any RFID tag 126 may be used in the applications herein as the asset tag 124. Some examples include near-field communication (NFC) tags, low-frequency RFID tags, ultra-high-frequency (UHF) tags, or others. In general terms, RFID technology uses radio waves to send and receive information between a passive tag and an RF reader that may be part of a detection station. Unique information, e.g., an identification code, can be programmed into each individual tag to allow tracking and identification of that tag. While passive tags are preferred, other embodiments may include active tags, i.e., ones that includes batteries.

Referring primarily to FIG. 2, in one illustrative embodiment, each asset tag 124 is an RF Tag 126 that contains an antenna 128, nonvolatile (or non-transitory) memory 132 (or asset-tag memory), and a rectifier and transmit circuit 136.

The nonvolatile, or non-transitory, memory 132, which could take the form of solid-state memory or continuity traces or any other suitable memory (see below for other examples of memory), provides a unique serial number or code for a given asset tag 124, or RF tag 126. This serial number is programmed into the tag 126 prior to its deployment, or may be programmed again when the tag 126 is recycled for use on a different animal. Additional components can be included in the tag 126, such as a micromechanical accelerometer 140, provided that the power consumption of such a device is within the power budget of the energy delivery to the tag 126 from the reader or detector station 116. Those skilled in the art will appreciate the function and variations available in the RFID asset tag 126.

Referring now primarily to FIGS. 1 and 3, an illustrative embodiment of a detector station 116 is presented. The detector station 116 is a self-contained device mounted in the vicinity of the water trough 112 or feeding trough 108 of the feedlot 104 or other location where monitoring is desired. A plurality of detector stations 116 are deployed in the feedlot 104. Each detector station 116 is typically mounted within the range of 0 to 12 meters of the applicable trough 108, 112. The detector station 116 contains a passive tag reader or detector (the “detector”) 144, a processor and non-transitory memory (e.g., microcomputer 148), and a relay 152.

In one illustrative embodiment, the detection station's 116 detector 144 is a passive RFID tag reader that emits a tuned radio wave that powers the RF asset tags 124, 126 that fall within the detector's 144 range of communications or detection zone. A detection of such a tag 126 occurs whenever the tag 126 borne by an animal 120, e.g., cow, becomes sufficiently close to the detector station 116 (nominally within 10 meters). In some embodiments, detection occurs in the range of 0-12 meters. When this radio wave impinges on the tag 126, an antenna 128 (FIG. 2) built into the tag 126 captures the incoming radio wave and converts the radio wave's energy to direct current (DC) voltage to power an on-board transmitter, memory, and possibly other devices or sensors 140, such as an accelerometer. The detector station's detector 144 reads a unique identification code, ID, stored within the RF asset tag 126 of a given animal 120 to enable the unique tracking of the movement and habits of the animal 120 (e.g., cow).

Referring still primarily to FIG. 3, in one illustrative embodiment, the detector station 116 includes a power source 156, which is a battery (or other source of energy) suitable for outdoor usage and may include environmental recharging components such as solar or wind generators. Those skilled in the art will appreciate that the power source 156 may be a hard wired electrical source in some embodiments. The detector station 116 further includes the asset tag detector 144, or passive tag reader, which is the component that detects the proximity and motion vector of an asset tag 124, 126.

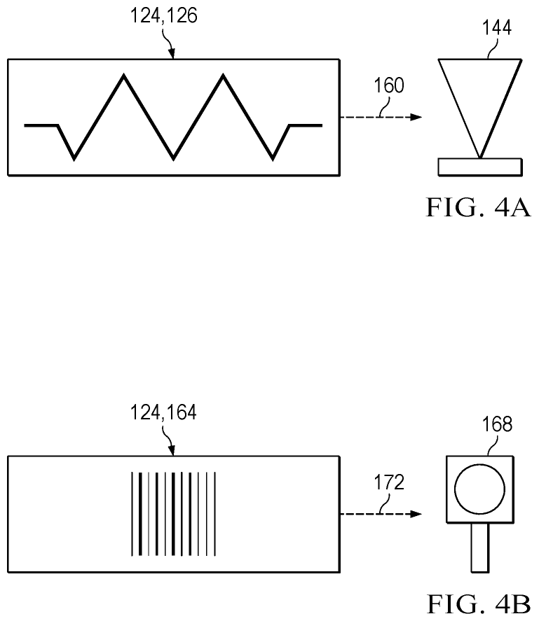

Referring now primarily to FIGS. 4A and 4B, an alternative illustrative embodiment of an aspect of the system 100 is presented. In this embodiment, in lieu of an RF passive asset tag 126 (FIG. 4A), other passive tag technologies are used as suggested in FIG. 4B. In FIG. 4A, the RF receiver assembly within a passive RF tag 126 has an RF link 160 to an RF detector 144 in a detection station 116 (FIG. 1). In the alternative design of FIG. 4B, the RF asset tag 126 is replaced with a visible bar code 164, or QR code or other visual indicia, on a tag 124 whereby the detector station 116 (FIG. 1) is equipped with a camera 168, or cameras in lieu of an RF detector/read circuit 144. The camera(s) 168 in the detector station 116 detects and visually reads 172 the visible codes 164. As in the RF tag case, the codes imprinted on the tag 124 would be unique to the asset tag, hence the animal wearing the tag 124.

Referring again primarily to FIG. 3, the detector station 116 also contains a processor (or detector station processor) and memory (or detector station memory), e.g., a microcomputer 148, which assimilates the movement information from the RF asset tags 124 that the detection station 116 encounters, as well as other tracking artifacts from animal movement. The microcomputer 148 includes non-volatile memory (or detector station memory) for holding programming for certain tasks. As discussed below, the microcomputer 148 may also reduce the data transmitted by the relay 152 to the gateway 176 (FIG. 1) to conserve spectrum and detector station battery energy. Depending on the proximity detection technology and receive range of the detector 144, there may be one or more detector stations 116 set up along the feeding troughs 108 and water troughs 112.

The relay 152 within the detector station 116 receives events from the detector station's detector 144 as process and such events from the detectors of other detection stations 116. After processing by the detector station's microcomputer 148, the relay 152 of each detector station 116 transmits the processed position, movement, and behavior information to the gateway 176, typically using available wireless communication mechanisms including, but not limited to, LoRa, BLE, WiFi, ethernet, etc., and then to an asset management system 180 (FIG>1) using a wired or wireless communication generally referenced as network 184.

Due to the nature of the feedlot environment, in many cases it may be desirable to deploy a plurality of detector stations 116 across a relatively large geographic area without access to an AC power source or other hard-wired power source. The detector station power source 156 (FIG. 3) may therefore be a battery that can operate in an outdoor environment and may use recharging technologies such as solar or wind to recharge the batteries. The power source 156 may include several hot-swappable batteries to facilitate field maintenance and upgrades without impacting the detector station's 116 operational state. If stable AC power or other power is available, the available power may be used as the power source 156 for detector stations.

The detector station 116 receives and processes proximity and motion data from any asset tag 124 that is within its field of operation (or vicinity or detection zone) of the detector 144. The detectors 144 in a plurality of detector stations 116 may work in tandem to correlate data from detected asset tags 124 in order to determine the precise location of an asset tag 124, as described elsewhere in this disclosure. The detector 144 is able to collect information from each asset tag 124 within the detector's receive zone, or detection zone, such that the collected information can be used by algorithms and analytics operating on a processor with associated memory, e.g., a microcomputer within the detection station 116, and in the remote server of the asset management system 180 (FIG. 1) as desired, to make accurate deductions about the eating and drinking behaviors of each individual animal 120. The detector station 116 includes a clock for timing aspects of the data collection. The specific information that is collected by the detector 144 and made available to other components varies depending on the specific embodiment of other components such as the asset tag 124, proximity sensing technology, motion sensing technology, etc. as one skilled in the art will appreciate. The information that may be sent or processed to determine information may include for different time intervals the total eating time, total drinking time, movements, current estimated location, time of day, eating/drinking habits, socialization habits such as proximity to other animals, etc. In addition, additional sensors or data may be recorded for the same time periods, such as, weather conditions, including temperature, humidity, and precipitation. The number of drinking or eating periods may be recorded as well; for example, an animal may drink five minutes and then not be detected for 15 minutes before being detected again whereby a second drinking period is established. This information may processed in various ways as discussed elsewhere herein.

The relay component 152 (FIG. 3) within a detector station 116 may be used for transferring information (e.g., relay signals) from the detector station 116 back to the asset management system 180 using the communication link 158 (FIGS. 1 and 3) to the intermediary gateway 176, which provides backhaul networking connectivity 184 to the asset management system 180. Typically, the communication link 158 is wireless, but in some embodiments could be wired. The relay signals are the communication between the detector station 116 and the gateway 176. In some instances, “communication link” may be used to reference the first link 158 and the link from the gateway 176 to the asset management system 180 regardless of whether wired or wireless or what is used for the linkage. Similar to the detection signals, one skilled in the art will appreciate that when RF technology such as LoRa or BLE is used, RF engineering principles may be employed to ensure efficient and effective use of the wireless medium.

Since temporary communication issues may be caused by outages or interference events such as large trucks or other obstacles in the feedlot 104 that impact RF signals, the relay may implement store-and-forward logic to ensure that information is reliably communicated back to the asset management system 180 through an available gateway 176. The system 100 may include signals from the asset management subsystem 180 back to a transmitting detector station to acknowledge receipt of information; if not received in a certain time frame, the information may be retransmitted until a receipt is acknowledge. Those skilled in the art will appreciate that many store-and-forward logic approaches may be used.

The wireless gateway 176 provides the interconnection between each detection station's 116 relay 152 and a remote server (not explicitly shown) that operates the asset management system 180. The backhaul connectivity 184, or network, between the gateway 176 and the asset management system 180 may be fixed or wireless using proprietary or standard telecommunications infrastructure, e.g., LTE, 5G, cable, fiber, or other as those skilled in the art will appreciate.

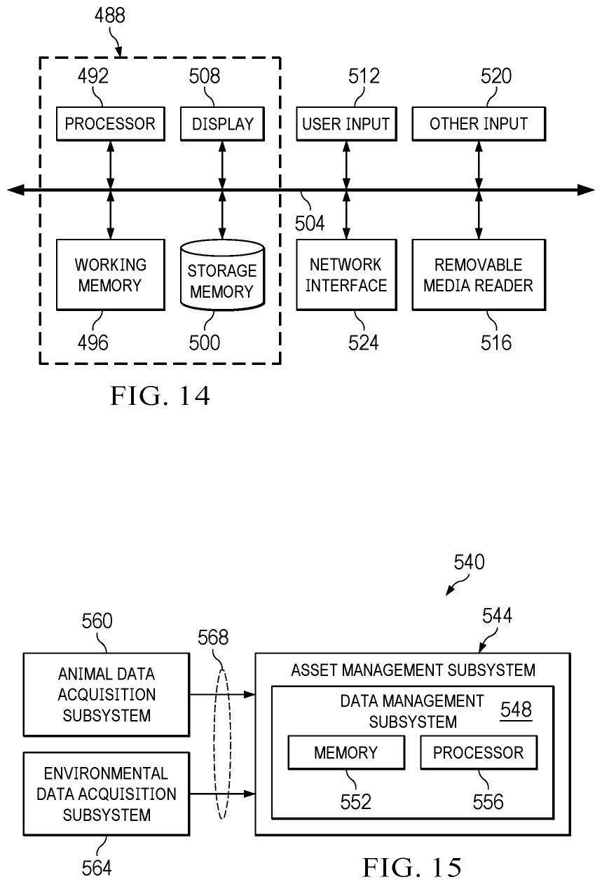

The asset management system 180 takes in data from the detector stations 116 from a multitude of asset tags 124 and analyzes the data for cattle movement and feeding/drinking within one or more feedlots 104 and may develop various health data. This system 100 monitors the status of the cattle movement, drinking, and eating within the covered feedlots, and provides real-time or periodic reports on the cattle movement, drinking, eating and behavior. Reports are transmitted via fixed or wireless communications services to smartphones, computers, tablets and other consumer-level devices held by the operators and owners of cattle ranches, feedlots, or other facilities. One asset management system 180 can be shared by multiple operators of feedlots, or owned and operated by individual feedlot owners/operators or other service providers. The asset management system 180 may include programmable instructions that monitor the data and highlight or provide alerts for data outside of any desired, predefined ranges. Suitable hardware that may be used with the asset management system 180 is shown in FIG. 14 further below as well as components that may be used in other aspects. Additional aspects of how the data may be monitored and used are described further below.

In operation of one illustrative embodiment, an illustrative system for monitoring animals 120 within a feedlot 104 identifies when an asset tag 124 (and therefore an animal) is within close proximity of a feed trough 108 or water trough 112, and uses such trough proximity data and in some instances other available information to deduce with a high degree of confidence that the animal 106 is eating or drinking at the food trough 108 or water trough 112.

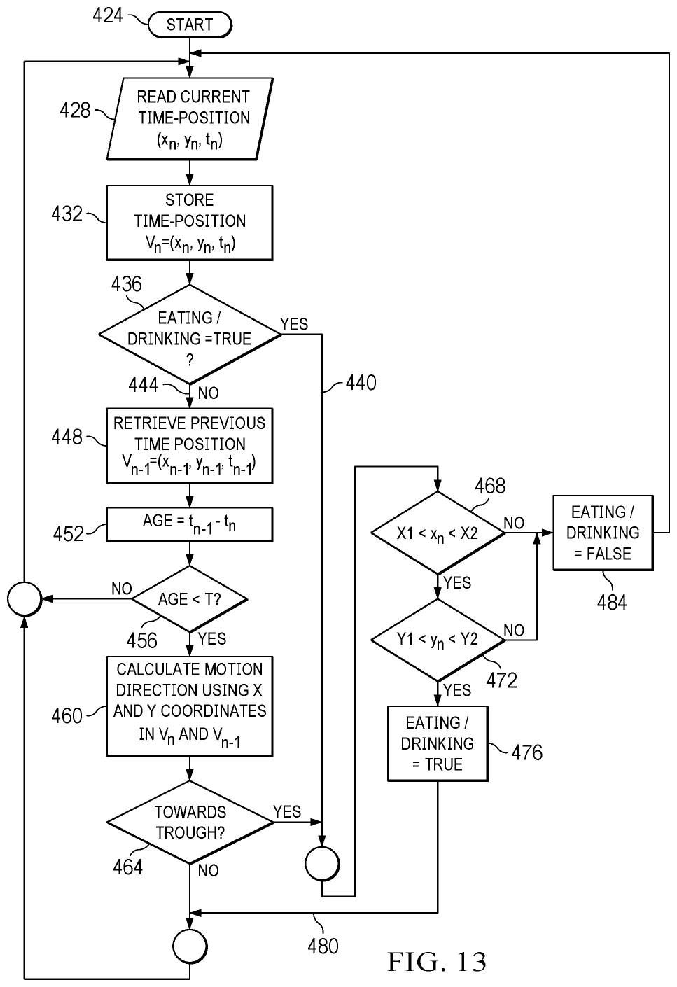

The primary information emitted by any asset tag 124 is the asset tag identification. Another form of information is the position of the asset tag 124 within the feedlot 104, or other monitored area. The position can be determined by a number of approaches. In one example, the position is determined using simply the proximity to the closest detector station 116, as determined by which detector station 116 has detected the asset tag 124 within its operating range. In another illustrative embodiment, the position is determined using signal-level detection (e.g., RSSI level). This approach considers the strength of the returned signal to the detector station. In still another example, the position is determined using time differences of arrival (TDOA) methods coordinating among a multiplicity of three or more detector stations 116. Time difference of arrival may be used for triangulation. In yet another example, the position is determined using angle of arrival method coordinating among a multiplicity of two or more detector stations 116. The vector of the animal is used. As still one more approach, other embodiments may use active tags to support GPS and other geolocation techniques that simply transmit location directly from the tag 124. Regardless of technique, the position information can be used to determine whether an asset tag 124 (and therefore the animal) is in close enough proximity to a feed trough 108 or water trough 112 to be eating or drinking, respectively. See, for example, the process presented in connection with FIG. 13 below.

Additional information, in the form of a motion vector, is generated by motion of the asset tag 124 relative to one or more detector stations 116. The motion vector provides information about the direction, speed, and possibly acceleration of an asset tag 124. This information can be used to determine whether an animal is (or was recently) walking towards, away from, or in parallel to a trough 108, 112. The elements of the motion vector (direction, speed, acceleration) may be determined by comparing the asset tag data at nearby detector stations 116 over intervals of time. Such comparisons can make use of proximity information (i.e., when only one detector station 116 can receive a close-range asset tag 124), multilateralization across multiple detector stations 116, comparison of RSSI signal levels, or other techniques.

More information can be contained in the movement characteristics of the animal 106, even while it is in a non-changing position. In one illustrative embodiment, readings from a chip-scale accelerometer, or micromechanical accelerometer, that is built into the asset tag 124 as an additional sensor 140 (FIG. 2) may be used, even when the asset tag 124 is running as a passive device. Accelerometer readings can indicate the head motion of the animal, thereby providing a more accurate assessment as to whether the animal is drinking, eating, or engaging in other behavior (e.g., sleep).

By combining one or more forms of information (position and motion) and performing analysis over time, the system 100 can support accurate predictions about whether an animal 106 is properly eating or drinking. A simple heuristic example could be expressed as follows: A first asset tag 124 first moves 10 meters from its original position near the center of the feedlot 104 towards the feed trough 108 in 8 seconds, ending at a position that is within 10 cm of the feed trough 108. The asset tag 124 remains in that location for 5 minutes. This motion and position characteristic is consistent with that of an animal 120 that is eating. Another example is as follows: an asset tag 124 moves 3 meters from its original position, which was next to the food trough 108, in a direction away from the food trough 108 at an angle of 45 degrees. The asset tag 124 has not been in the vicinity of the food trough 108 for the last minute, and the motion characteristic is consistent with that of an animal that is walking and not eating. In each instance, the data may be transmitted and analyzed.

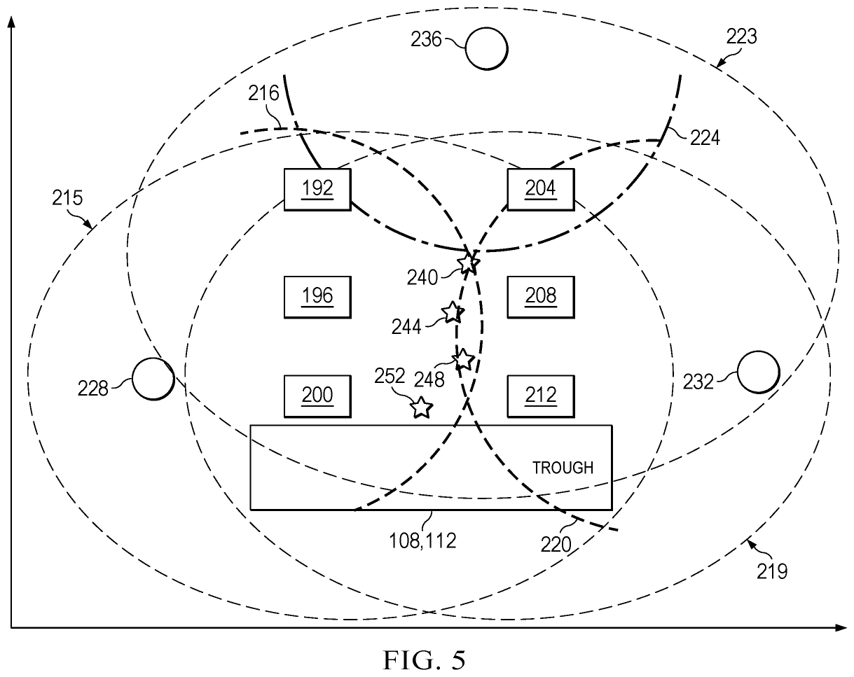

The passive asset tags 124, such as passive RFID tags 126, do not contain an internal power source or active electronic components, but rely on an external stimulus, such as the RF energy supplied by an RFID reader 144 to generate the RFID asset tag backscatter signal. The movement situations described above can be tracked with passive asset tags given that such tags can yield useful proximity information for the detection stations 116. An illustrative example is presented in connection with FIG. 5.

Referring primarily to FIG. 5, a number of stationary reference asset tags 192, 196, 200, 204, 208, 212, which are distributed at known positions within the detection fields or zones 215 (for detector station or RFID reader 228), 219 (for detector station or RFID reader 232), 223 (for detector station or RFID reader 236) of three RFID readers or stations 228, 232, and 236, are shown. The detection fields or asset tag distance (radius) 216, 220, 224 for particular tags are shown as dotted bold arcs; they may be circular or elliptical patterns about each station 228, 232, 236. Using the RSSI values from the reference asset tags 192, 196, 200, 204, 208, 212 distributed within its RFID detection fields, each detector station 116, e.g., stations 228, 232, 236 is able to form a logical mapping between the RSSI readouts from the reference asset tags 192, 196, 200, 204, 208, 212 and the distance between the detection stations 228, 232, 236 and the reference asset tags 192, 196, 20, 204, 208, 212. The degree of accuracy and the overall robustness of the system 100 is increased as the number of reference asset tags 192, 196, 200, 204, 208, 212 and the number of detection stations 116 are increased. The reference tags may be used during calibration or in some embodiments may be permanently maintained in the detection fields 215, 219, 223.

When each of the detector stations 228, 232, 236 in the above example receive the backscatter signal from a particular asset tag, the RSSI is converted into a distance measurement, or range, using the readings from the reference asset tags 192, 196, 200, 204, 208, 212 as a baseline. The distance measurements from each of the detectors 228, 232, 236 are then correlated to determine the specific X and Y coordinates of the particular asset tag 124 in question. This is illustrated in FIG. 5 by showing the approximate intersection of the three radii 216, 220, 224 for a particular asset tag at time to showing position 240.

In that example, the location 240 may be determined by knowing the range for each station 228, 236, 232 and finding the intersection of the three range-based arcs 216, 220, 224. In another embodiment, the stations 228, 236, 232 may determine a range and bearing and average the resultant location data or use a best fit for the three stations 228, 236, 232. By repeating one or more of these location approaches over time or other techniques, a motion vector for a particular asset tag is constructed and its motion path determined as illustrated by the points in time t₀, t₁, t₂ and t₃ and the corresponding positions 240, 244, 248, 252.

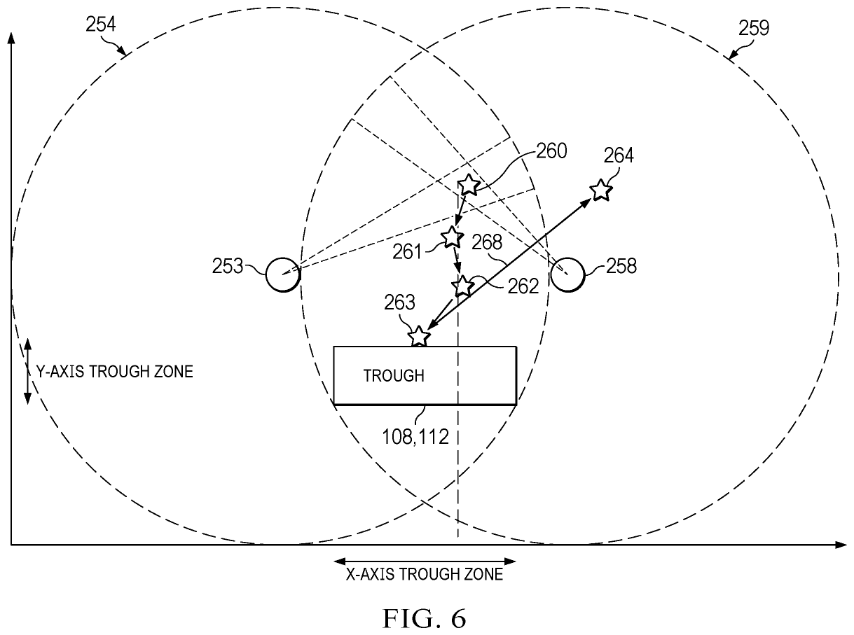

Referring now primarily to FIG. 6, another illustrative embodiment is presented that includes a first detector 253 having a detection zone 254 and a second detector 258 having a detection zone 259. As before, the location of a particular asset tag at successive location may be calculated, e.g., at times t₀, t₁, t₂, t₃, and t₄, may be located as positions 260, 261, 262, 263, 264. The positions 260, 261, 262, 263, 264 over time may be used to calculate motion vectors that show the path of the asset tag towards or away from the trough 108, 112. In this example, the asset tag is shown moving towards the trough 108, 112 between to and t₁ (i.e., between position 260 to position 261) and again moving toward the trough 108, 112 between time t₁ and t₂ (i.e., between positions 261 and 262). Between time t₂ and t₃ (i.e., between positions 262 and 263) the movement is still toward the trough 108, 112. The position 263 at t₃ is at the trough 108, 112.

The movement from t₃ to t₄ (i.e., from 263 to 264) is away from the trough 108, 112. Again, at time t₃ (location 263), the X and Y coordinates fall within the X-axis trough zone and Y-axis trough zone respectively, which results in the declaration of a “feeding start” event. At time t₄ (location 264), the asset tag 264 has moved outside of the Y-axis trough zone and X-axis zone, and the motion vector 268 indicates movement away from the trough 108, 112. These conditions are used to declare a “feeding end” event has occurred at position 264.

Note that while the use of RSSI with reference tags (see 192, 196, 200, 204, 208, 212 in FIG. 5) was described as a method used to calculate the position of an asset tag above, other location tracking approaches suitable for passive asset tags may be used. As another example, in FIG. 6, the bearing for each station 253, 258 may be used to determine the location as suggested for the asset tag at position 260. In some embodiments, each detection station 116, e.g., stations 253, 258, may determine range and bearing and therefore have redundant data from the other station that can be processed to avoid sending both to the gateway as suggested further below. The location tracking methods can be combined with machine learning to determine the asset tag positions over time, where the machine learning is trained by the known positions of the reference tags described above.

In scenarios where multiple detectors from multiple detector stations are deployed to cover a particular area, there can be overlap in the detection zones of adjacent detector stations. While this overlap can be desirable—such as for purposes of multilateralization or other positioning algorithms—there may be side-effects of zone overlap depending on the detection technology that is used. For example, with RFID-based detection, there may be interference between the RF signal from an adjacent detector and the backscatter signal from an asset tag on an animal within the overlapping zone. One may mitigate interference in such scenarios by varying the frequency between adjacent detectors, using collision avoidance/detection techniques such as time-slicing and staggering RFID carrier signal transmission for adjacent antennas, and employing error correction to improve the ratio of successful message reception. The use of such techniques to mitigate interference between adjacent asset tags and detection stations may be included in the illustrative embodiments herein.

To conserve spectrum and battery drain within the detector stations 116 (when the detector stations are powered by batteries instead of power lines), data reduction methods may be employed that limit the amount of data transmitted between the detector stations 116 (FIG. 1) and gateway(s) 176. As an illustrative example of data reduction, the detector stations 116 may not forward each individual detection data to the asset management system 180, but rather provide interval-based statistical reports. As an example of the interval-based statistical report, the data may be sent every one minute, two minutes, five minutes, ten minutes, or some other interval.

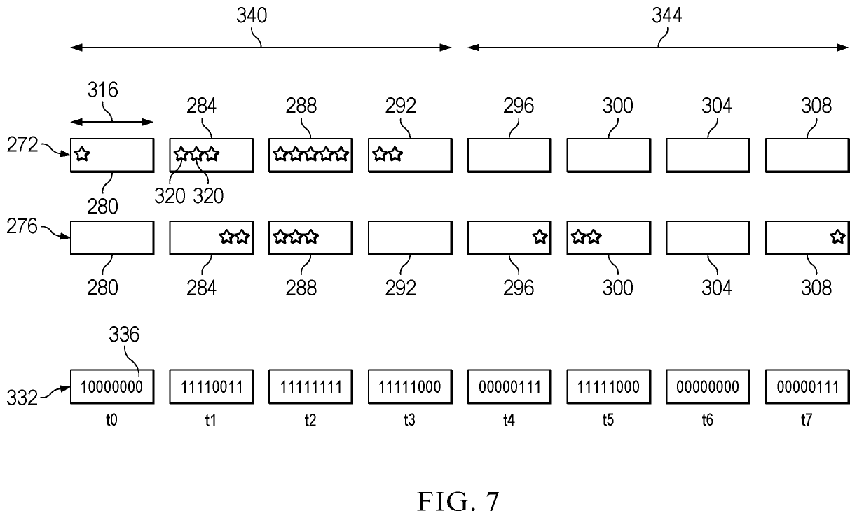

Referring now primarily to FIG. 7, a schematic diagram is presented that presents smoothing and filtering functions within detector stations 116. In this figure, two detector stations 116 (a first detector station 272 and a second detector station 276) have an overlap zone, which is where both detection stations receive signals from the same asset tag. As a result, a particular asset tag 124 is detected by both stations when the asset tag is in the overlap zone. This may be shown by considering data for a number of sequential time periods.

Sequential time boxes 280, 284, 288, 292, 296, 300, 304, and 308 present data recorded for sequential time intervals. Each of the time boxes 280, 284, 288, 292, 296, 300, 304, and 308 are labeled at the bottom with the applicable time segment: t₀, t₁, t₂, t₃, t₄, t₅, t₆, and t₇. While only eight are shown other segments may be used. Each time box represents a time window of a given duration, which may range from minutes to hours, e.g., 30 seconds, 2 minutes, 5 minutes, 10 minutes, 30 minutes, one hour, two hours, or other value. Each time window may be referred to as an “era” 316. A star symbol is used to show asset tag encounters during the era 316, i.e., for a specific time box. Each star 320 within an era 316 represents an individual detection event of a specific animal's 120 presence, e.g., asset tag-A. In this example, within era 280 on the left of the figure, an asset tag-A 124 was detected once by the first detector station 272 but was not detected at all by the second detector station 276. This shown in the data recording by only have one star in time box 280 of the first station 272 and no stars in the time box 280 of the second station 276.

The asset tag-A was in the overlap zone in the next two times boxes, or eras, 284, 288. Thus, one can see that during the time period covered by eras 284 and 288, the asset tag was within the overlap zone—and so detected by both stations 272, 276—as shown by the stars therein. Furthermore, one can see that at era 280 (t=t₀), asset tag-A was only detected once by the first detector station 272, while at era 284 (t=t₁) and 288 (t=t₂) there were more consecutive detection events in both stations 272, 276.

The data developed by the two stations 272, 276 may be filtered and smoothed. The smoothing and filtering utilizes a detection threshold, which one can define as the minimum number of detection events that are required to occur within one era in order to determine that a positive detection has occurred for a given station 272, 276. As an example, if one considers the detection threshold to be three events, then the smoothing and filtering logic at the first station 272 would generate a detection notification only for eras 284 and 288, and at station 276 it would only generate a detection notification for era 288. As another example, note that while asset tag-A was detected at the second station 276 during era 296 (t=t₄), era 300 (t=t₅), and era 308 (t=t₇), during those times, if the detection threshold was set at three encounters, then it never exceeded the detection threshold to generate a detection notification for eras 296, 300, 308. That data may not be sent as it is considered spurious in some way. As another example, if the detection threshold is set at two, then, the first station 272 would report detections at eras 284, 288, and 292, and the second station 276 would report detection events at eras 284, 288, and 300. The threshold may be set at various event levels in different embodiments; for example, it may be 1, 2, 3, 4, 5, 6, or more.

To further increase the accuracy, the detection notification that is generated by the detector station, e.g., detector station 272 or 276, for a given era 316 may also include a granular time-based report—see the bottom row in FIG. 7. Reference is made to the final row in FIG. 7, but the row does not correlate with the rows above it other than having the same time scheme. The granular time-based report may be called a detection bitmap 332. Each bit 336 in the bitmap 332 represents a unit of time within the corresponding era 316. A value of “1” indicates that the asset tag 124 was detected within that time unit and a value of “0” indicates that the asset tag 124 was not detected within that time unit. By providing a granular report of detections per time-unit, algorithms that process the data can draw more accurate conclusions about animal behavior.

Consider the era at to, that era shows with the code “10000000” that for the station being reported for the time segment, which is broken into 8 units, there was a detection at the start and thus the code begins with a “1” but then had the remaining seven units with no detections.

To further elaborate, consider time units t₃ and t₄ in bottom row of FIG. 7. The first era t₃, represented by “11111000,” started with five consecutive detections and was followed by three time units of no detection. The second era t₄, represented by “00000111,” shows no detections for five units and then has three detections for the final three time units. The gap formed by three no detections in era t₃ and five in era t₄ may be interpreted as the delineation between two distinct events. For example, the gap in detections may indicate two distinct drinking events whereby an animal drank for five consecutive time units, left for 8 consecutive time units, and then returned to drink again at the end of era t₄. Using a bitmap 332 to represent time units reduces the amount of data, and therefore wireless resources and power required to transmit the information. Various data compression algorithms may be used to further conserve wireless resources and power utilization as one skilled in the art would appreciate.

By aggregating detection events within an era, and by applying the detection threshold to filter out spurious or inconsequential detection events, the number of messages that are transmitted wirelessly from the detector station 116 to the gateway 176 are reduced, thereby conserving wireless resources and power, without sacrificing any of the motion estimation intelligence. However, the metadata associated with the filtering and smoothing also offers valuable insights into the behavior of a specific animal.

In one illustrative embodiment, in order to communicate the data from the detection station 116 to the asset management system 180 (FIG. 1), the system 100 may define the concept of an epoch, and two epochs 340, 344 are shown at the top of FIG. 7. An epoch is a time period consisting of several consecutive era's 316. The epoch information may be used to efficiently communicate with the asset management system 180 (FIG. 1) via the gateway 176 (FIG. 1). The first epoch 440 includes eras 280, 284, 288, 292, and the second epoch 344 includes eras 296, 300, 304, and 308. In one illustrative embodiment, an era 316 may be defined as one hour, and an epoch 340, 344 as a collection 24 consecutive one-hour eras. In this embodiment, the detection station, with its smoothing and filtering function, generates a report at the end of each epoch 340, 344 to inform the asset management system 180, or application management system, about how many times there were detection events during that epoch. It may report also how many did not meet the threshold criteria in some embodiments.

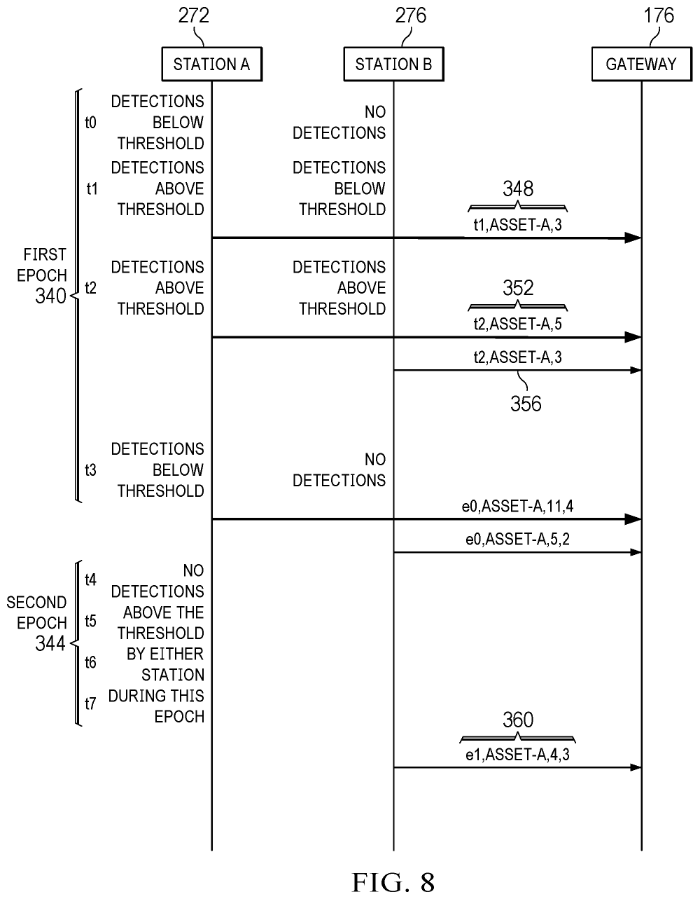

Referring now primarily to FIG. 8 and to a lesser extent FIG. 7, a schematic representation of data transmitted to a gateway, e.g., gateway 176 (FIG. 1), from the two detection stations 272, 276, which have an overlap zone, is presented. FIG. 8 shows how the smoothing and filtering function may present data to the corresponding asset management system 180 (FIG. 1) using notification messages. The detection events and notifications in FIG. 8 correspond to the detection events illustrated in FIG. 7 for the two stations 272, 276 for the two epochs 340, 344 and their corresponding eras as shown in the top two rows.

For example, considering the vertical time indications shown in FIG. 8, at the end of to t₀, there is no notification made because the one detection made in era 280 at the first station 272 is below the threshold (assuming a threshold of three detection encounters for this example) and the second station 276 had no detections; consequently, there was no notification. At the end of t₁ (era 284), the report shows that the first detector station 272 (or station A) sends a notification 348 that the first detection station 272 detected the proximity of asset-A three times in era t₁. The second station 276 had no notification since the two detections are below the detection threshold.

At the end of t₂ (era 288 in FIG. 7) both the first station 272 (station A) and the second station 276 (station B) report that they have detected asset-A (since it is in an overlap zone). The notifications 352 for the first station 272 indicates five detection events, and the notification 356 for the second station 276 indicates three detection events. Similar reporting occurs for the other eras of the epoch 344. At the end of the first epoch 344 (also referenced as e0), a notification is sent from the first detector station 272 to the asset management system 180 via the gateway 176 that during first epoch 344 (e0), asset tag A had a total of 11 detection events in four different eras, and the second detector station 276 sends a notification that asset tag A had a total of 5 detection events in two different eras.

Going to the data for the second epoch 344, no notifications are sent at the end of t₄, t₅, or t₆ because either there were not detections or the detection events were below the detection threshold. At the end of the second epoch 344, a notification 360 is sent that for the second epoch 344 (also referenced as el), asset tag A was detected four times in three eras.

It should be noted that FIG. 8 shows both the first station 272 and the second station 276 communicating directly to the gateway 176, but in some embodiments, one station may communicate to the other and that station communicates only once for both stations to the gateway. Moreover, in some embodiments, the stations may alternate which communicates or it may be based on who has more power in their respective batteries.

The system 100 performance in terms of sensitivity, accuracy, timeliness and efficiency can be tuned by selecting different values for the concepts that are described in this disclosure. The following table provides a summary of those values which may be readily controlled by the configuration settings in one illustrative embodiment: era, epoch, and detection threshold.

TABLE 1

| Parameter | Description |
|---|---|
| Era | A window of time, or interval, during which detection events |
| | from the proximity sensing layer (detection station) are |
| | aggregated |
| Epoch | A collection of consecutive eras for which periodic aggregate |
| | statistics are reported for the asset management system |
| Detection | The minimum number of detection events that must be present |
| Threshold | from the proximity sensing layer (detection station) within a |
| | given era in order to produce a detection notification |

The ability to synchronize the clocks of the various detector stations 116 and gateways 176 is a consideration. This is for two main reasons. First, synchronization enables correlation and de-duplication of detection events from different detector stations 116. Second, synchronization enables coordination and use of different transmission windows among the various detector stations in order to minimize interference, collisions and retransmissions. Thus, synchronization may ultimately result in more effective use of limited wireless resources and more power efficiency.

While power efficiency at the detector stations 116 is significant due to the fact that in most cases the detector stations 116 are battery powered, the detector stations 116 may be sufficiently supplied to be able to support GPS time synchronization, which is a simple time synchronization approach. With such synchronization, given a sufficiently large time window used for an era (which typically range from minutes to hours), it is sufficient for the precision requirement between the different detector stations 116 to be less stringent. Such reduced precision allows for time synchronization to be achieved by means of a message exchange between the detector station 116 and the gateway 176. An approach to achieve this in the LoRa environment has been described by the LoRa Alliance in the LoRaWAN Application Layer Clock Synchronization Specification, which describes clock synchronization messages exchanged between a LoRa node and gateway for this purpose and is known by those skilled in the art. Similar approaches can be used for other wireless protocols.

With their clocks synchronized, all detector stations 116 can use the same era and epoch identifiers when sending messages to the application management system 180 in the uplink direction. As described above, it is likely that there will be some degree of overlap between the detection zones of adjacent detector stations 116 that may result in duplicate detections as illustrated in FIG. 7. While this may not be an issue from an asset management system 180 perspective, transmitting a message (or notification) from the detector station 116 to the gateway 176 only for the message to be discarded further down the processing chain is a waste of wireless resources and power. The system may be configured to avoid such results.

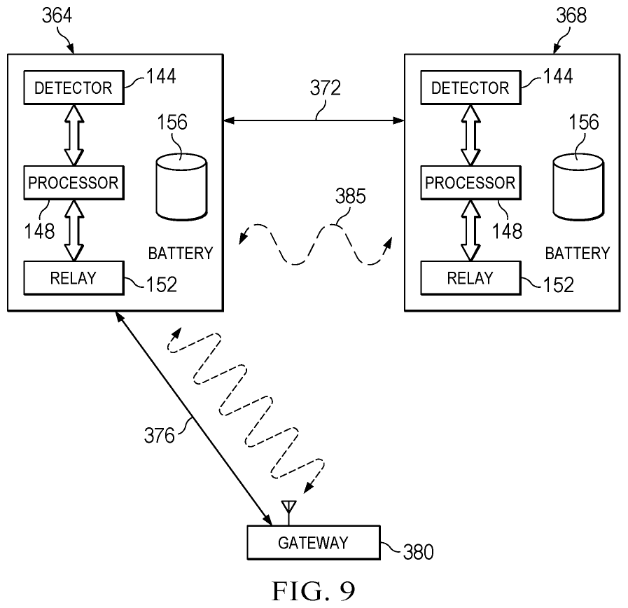

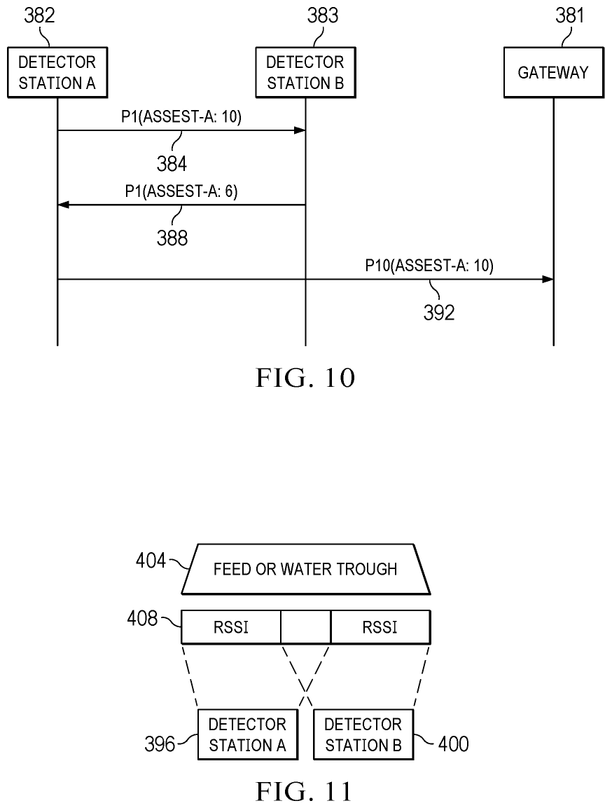

Referring now primarily to FIG. 9, an illustrative system is shown with two detector stations: a first detector station 364 and a second detector station 368. In this situation, there may be duplicate detection notifications unless steps are taken. Note that overlap only occurs between adjacent detector stations in relatively close proximity to each other (on the order of several meters). The first detection station 364 is separated by a distance 372 from the second detection station 368. This contrasts to the distance 376 between the first detector station 364 and an illustrative gateway 380, which is much further away (e.g., potentially on the order of several hundred meters). In this arrangement, the detector stations 364, 368 would consume more battery power to communicate with the gateway 380 than with each other. This distance disparity can be addressed by forming a low-power mesh network between the adjacent detector stations 364, 368 that can be used to perform message de-duplication at the edge, as referenced in FIG. 10.

Referring now primarily to FIG. 10, a schematic diagram presenting de-duplication of notifications is presented. Before relaying a detection event to the gateway 381 (380 in FIG. 9) at the end of an era, the detection stations 382 (364 in FIG. 9), 383 (368 in FIG. 9) use the low power mesh network 385 (FIG. 9) to exchange information about the detections for each asset tag within that era as illustrated by the first two messages at 384, 388. The messages are denoted as P1 to indicate that they require 1 unit of power to transmit.

In one illustrative embodiment, the detector station with the largest number of detections for a given asset tag within an era is elected as the primary detector and relays the detection notification to the gateway 381, as illustrated by the third message 392. The message 392 is denoted as P10 to indicate that it requires 10 units of power to transmit due to the significantly larger distance (see 376 in FIG. 9). This is just one example. Other techniques that may be used to elect the primary detector include but are not limited to using the first to detect as the primary, using the one with the strongest RSSI as the primary, assigning different priorities to different detector stations, alternating stations on a pattern, measuring battery remaining, one with the strongest backhaul signal, the one with the most reliable link, etc.

Continuing the above example, the first detector station 382 (station A) has incurred an overhead of 10% in relaying the detection event to the gateway 381 because the first detector station 382 expended the additional 1 unit of power to inform the adjacent detector station. The second detector station 383 (station B) has realized a power savings of 90% since the second detector station 383 avoided having to send a high-energy signal to the gateway 381 for the given interval.

The overall gain in power efficiency at a specific detector station depends on the ratio of duplicate detections and the number of notifications sent over the mesh network 385. Additional intelligence can be implemented within the detector station 382, 383 to only inform adjacent detector stations when there is a reasonably high probability that a given asset tag was also detected by that station as will be presented next.

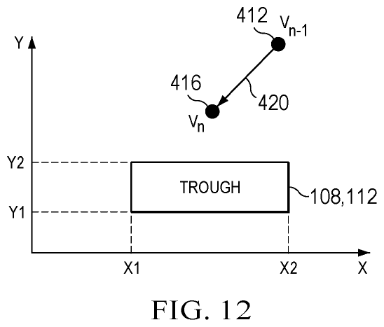

Referring now primarily to FIG. 11, one illustrative approach to minimize or reduce messages on the mesh network (e.g., 385 in FIG. 9) is presented. This illustrative embodiment shows two detector stations 396, 400 using RF technology such as RFID or BLE as the proximity sensing technology near a feed trough or water trough 404. The received signal strength indicator (RSSI) 408 of the detected asset varies depending on the asset's location within the detection field, or detection zone. The first detector station 396 can use this information to decide whether the first detector station 396 needs to inform its neighboring detection station, the second detector station 400, of a detection event by using the RSSI as a predictor of the probability that the asset was also within the detection zone of an adjacent detector station. The RSSI is proportional to the distance between the asset tag and the detector/reader antenna. If the RSSI is below a certain value that can be either fixed or automatically adjusted based on recent detections, it may be assumed that the asset tag 124 may also be near an adjacent detector station 116.

In another embodiment, if the detector stations 396, 400 can detect bearing and can be calibrated to know that when an asset tag has been recorded in a certain range for the bearing, there is a likelihood of overlap, but otherwise not.

Programmed steps may be used with the detected presence of asset tags by detector stations to determine how long an animal 120 has been drinking or eating (e.g., at a trough) as well as movements over time intervals. These steps may be done at the detector station 116 level by the microcomputer 148 (FIG. 3) and the resultant information transmitted to the gateway or may be done on the data by the asset management system 180 (by a microcomputer—see 492 and memory 500 in FIG. 14). An example will now be presented by first establishing a framework in FIG. 12 and then going through a process flow for the steps in FIG. 13 for one illustrative embodiment.

Referring now primarily to FIG. 12, a trough 108, 112, which may be a feed trough 108 or a water trough 112, is presented on a cartesian/X-Y space. The four corners of the trough 108, 112 are (x1, y1), (x2, y1), (x2, y2), and (x1, y2). For this illustration, uppercase and lowercase letters are used interchangeably. An asset tag 124 is shown at a first position 412 and then having moved to a second position 416 to define a vector 420. This may interpreted as the animal wearing the asset tag 124 is approaching the trough 108, 112. This framework is used for reference with the next figure.

Referring now primarily to FIGS. 12 and 13, and initially to FIG. 13, a schematic process flow chart for the process of determining movement and monitoring of an asset tag 124 is presented. The process starts at 424 and proceeds to read/detect the position at a current time as shown at input 428. The input is then stored at step 432 as Vₙ=(Xₙ, Yₙ, tₙ). That is, the X-Y position is saved for a time t. At interrogatory box 436 the process asks if a flag has been set to eating or drinking; that is, asks if an eating or drinking flag has been set to “true” elsewhere in the process. If true, the process continues on path 440, and if not, the process continues on path 444.

If negative, i.e., on path 444, the process will retrieve the previous position data, i.e., Vⁿ⁻¹, (Xₙ₋₁, Yₙ₋₁ tₙ₋₁) at 448 and then calculates the time difference between the present and the previous time at box 452 to determine the elapsed time, or age. Moving to interrogatory box 456, if the age is less than a max limit time, T, the process continues to box 460 and otherwise (if negative) goes back to input 428 for continued monitoring. If the data is current enough, the system will check the motion and otherwise it will just continue monitoring. In some embodiments, the maximum time (T) is 30 seconds, 1 minute, 2 minutes, 3 minutes, 4 minutes, 5 minutes, or anything therebetween. Other times may be used as well.

If not aged out at 456, i.e., age<T, the motion direction of the asset tag is calculated at box 460. This calculation includes a direction. The angle from a reference in the cartesian plane may be calculated for a vector and that used with a look-up table to determine if the direction is towards or away from the trough or alternatively the vector can be extrapolated to see if it hits the trough zone. For example, with reference to FIG. 12, for an asset tag at position 412 any vector at an angle in the range of about 225 to 270 degrees (where 3 pm on a clock face would be zero and measurement goes counterclockwise) would be toward the trough 108, 112.

At interrogatory box 464, the process considers whether the movement is towards or away from the trough 108, 112. If away from the trough 108, 112, the system will continue to monitor and goes back to input 428. If toward the trough 108, 112, the process continues to interrogatory box 468 where the process of determining if the asset tag 124 is at the trough is considered.

Determining if the asset tag is at the trough 108, 1112 is done first at interrogatory box 468 by asking if the x position is in the trough zone (i.e., between x₁ and x₂ in FIG. 12), and if so then asking at interrogatory box 472 whether the current y position is in the trough zone (i.e., corresponds with the trough with respect to y) at interrogatory box 472. If interrogatory boxes 468 and 472 are both true, the “eating” or “drinking” flag is assigned as “true” at box 476 and the process then goes back to input 428 as shown by path 480. The process will be set for each trough and will know if the flag is for eating or drinking, but for purposes of explaining both are referenced here. If either interrogatory box 468 or 472 is negative, then the process goes to step 484 and the process assigns “false” to the eating or drinking flag and the process continues to input 428. This is one approach, but those skilled in the art will appreciate that many approaches may be used with the developed data from the system 100.

Referring now primarily to FIG. 14, a schematic representation of a representative example of hardware components of a programmable computer 488 that may be used as or with the asset management system 180 (FIG. 1) or other computers referenced herein is presented. This is not meant to be limiting and those skilled in the art will appreciate that many computer systems might be used. A computer 488 comprises one or more processors, generally represented by processor 492, which comprise a CPU, for reading and executing instructions. Steps for carrying out the processes are encoded in one or more sets of instructions, or programs.

The computer 488 includes a processor 492. The processor is representative of implementations having one or more central processing units (CPUs), a graphics processing unit (GPU), other types of processors, and combinations of CPUs, GPUs, and other types of processors. The processor 492 may communicate with a main or working memory 496 and a storage memory 500 over one or more buses represented by bus 504. The main or working memory is intended to be generally representative of short-term memory used by the processor for storing instructions being executed and other data being processed, such as random access memory (RAM), including cache memory. Storage memory is representative of longer-term memory for storing program instructions and data structures, such as hard disks and solid-state disks. Bus 504 is intended to be representative of all types of bus architectures and other circuits for enabling communication between the processor 492 and other components of the computing machine.

The computer 488 may also be connected with other hardware to form a computing system or to implement a special purpose device that utilizes the computer's processing for control, communication, or other functions. For example, if intended to interact with a person, it may communicate with a user through visual display 508. Examples of visual displays include monitors such as CRT (Cathode Ray tube), LCD (Liquid Crystal Display), LED (Liquid Emitting Diode), OLED (Organic Light Emitting Diode), Plasma Monitor liquid crystal displays, projectors, and other devices for creating visually perceptible images. The computer may also include one or more devices for enabling a user to enter information, control, and interact with the computing machine and a graphical user interface presented on the visual display. These are collectively designated 512 and may include, for example, depending on the computing machine, a keyboard, a mouse or track pad, a touchscreen, a microphone, and similar devices for providing interaction. A media reader 516 for reading removable media, such as an optical disk drive that reads optical media or a memory card reader, enables the computing machine to read data from and/or write data to removable data storage media. Those skilled in the art will appreciate that other components may be used.

The computer may also communicate with other types of other input and output devices through various type interfaces. These devices are generally designated 520. Examples include cameras, a Global Positioning System (GPS) receiver, and environmental sensors, such as temperature, light, and acoustic sensors, accelerometers, and gyroscopes. To communicate with other computers (or devices in which computers have been embedded), the computer may be connected to one or more network interfaces 524 that enables the computing machine to communicate with other computers and devices using known networking protocols. The network interfaces may be wired, optical, or wireless.

Program instructions to executed by the processor and data structures written or read by such processes, are stored on machine or computer readable media. Examples of such computer readable media include, but are not limited to, working memory 496, storage memory 500, as well as removable media being read by reader 516. While the machine-readable medium in the example embodiment can be a single medium, the terms machine readable medium and computer readable medium are generally intended to also include, unless the context clearly indicates otherwise, multiple media, and can be centralized or distributed among several computing machines.

A processor can be a microprocessor, a special purpose processor, or a combination of one or more processors of the same or different types. A few examples of machines or devices comprising or containing programmable computers include mainframe computers, mini computers, personal computers (PC), web appliances, network routers, switches, bridges, hardware firewalls, mass data storage devices tablet computers, set-top boxes, smartphones, personal digital assistants (PDA), and cellular telephones. As with other lists herein, the foregoing list is not to be limiting. Furthermore, multiple computers may implement a process, each performing only a part of the process, or a separate instance of the process.

The term “non-transitory machine-readable medium” or “non-transitory memory” means any tangible medium or media, but not transitory signals, that is capable of storing, encoding, or carrying instructions for execution by the computing machine and that cause the computing machine to perform any one or more of the processes described below, or that is capable of storing, encoding, or carrying data structures used by or associated with such instructions. Examples of non-transitory machine-readable media include, but are not limited to, nonvolatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks. Other forms of memory may be used. The memory may be referred to as non-transitory machine-readable storage medium at times.

Although not illustrated, most programmable computers have an operating system. An operating system (OS) is set of computer programs that manage computer hardware and software resources and provides common services for application and other programs that are executed by the computer. As explained below, a single hardware computer can be used to support multiple, separate virtual computing environments for supporting execution of a software application. Processes described below can be programmed as an application and executed directly by a hardware computer or in a virtualized environment.

A programmable computer may be embedded into a special purpose device for providing the logic for controlling the device or extending its functionality and include, or be combined with, a number of other elements, including ports for connecting, for example, keyboards and visual displays to allow a person to interact with the computer, and network interfaces for allowing the computer to communicate with other computers over a network. Examples of computers include desktop and laptop computers, computers that act as servers, routers, switches, mobile devices, embedded computing systems, and any type of machine with one or more central processing units for executing instructions to perform programmed processes. Those skilled in the art will appreciate that many computer systems may be used for the microcomputers referenced herein.

According to one illustrative embodiment, an approach that applies passive asset tags such as RFID tags for the purposes of: position determination and motion determination of cattle in a feedlot; determination of whether or not the cow is eating or drinking in the feedlot according to the cow's position in the feedlot over time; and determination from additional information acquired from a passive sensor, such as through a low-power accelerometer, that the cow is eating or drinking.

According to one illustrative embodiment, a livestock or cattle asset management system that can monitor and ascertain the consumption of feed and water by animals over a multiplicity of feedlots is presented. The asset management system 180 (FIG. 1) can process data for multiple feedlots.

In one illustrative embodiment, detector stations 116 are deployed about the troughs 108, 112. Two stations may be positioned at each trough 108, 112 within 1-2 meters throughout the feedlot 104. The detector stations 116 broadcast a radio signal that provides energy for a return from the RF asset tags 124 on the livestock. The livestock have the asset tags 124 attached, typically with an ear-tag placed in the ear of each livestock and each having a unique asset code. The detector stations 116 communicate with the gateway 176 that communicates with the asset management system 180. Each detector station 116 can broadcast constantly or be pulsed in a coordinated (synchronized) fashion to avoid interference. The processor and non-transitory memory of the detector stations 116 may cause the detector station to read the asset tags that come within range and coordinate with other nearby stations to reduce data transmitted. The detector stations filters and reduces data transmission.

The detector stations 116 filter by requiring the presence of an asset tag more than a threshold number of times for a time period in order to act on the detected asset tag. The detector stations 116 can reduce data by only transmitting for one station where multiple stations have received signals in the detection area of the detector station. See FIG. 10.

The kinds of data monitored by the asset management system 180 include total time at water trough 108, feed trough 112, and movement calculated by presence at different stations 116 for a time period, e.g., 24 hours period. The asset management system 180 can compare the recorded or determined values for each livestock with performance standards and alert management personnel concerning the livestock that are outside of the standards. The alerts can be been acted upon based on severity. If for example, the standard is to drink at a water trough for at least 15 minutes every 24 hours, and livestock number ABC has not had any water, a pushed alert can be sent to management that livestock number ABC is in a crises condition. This same kind of alert can be established for each variable—food, water, movement, or other variable. Other features can be built in such as asking the asset management to locate a particular livestock. In that case, it can search the position records sent and provide the most recent location for that particular livestock.

There are many illustrative embodiments of the disclosure. Many have been referenced elsewhere and some other examples follow here.

Example 1. A system for monitoring the activity of a plurality of livestock in a feedlot, the system comprising:

a plurality of asset tags for coupling to the plurality of livestock to be monitored, each asset tag having a unique identifier;

a plurality of troughs for feeding or watering;

a plurality of detector stations positioned proximate to the plurality of troughs;

a gateway for receiving signals from the plurality of detector stations, wherein the signals provide information on each of the plurality of asset tags as sensed by the plurality of detector stations; and

an asset managing management system comprising a processor and memory for executing instructions to determine and monitor activities of the plurality of livestock, wherein the asset management system receives signals from the gateway over a network.

Example 2. The system of Example 1, wherein the plurality of asset tags comprises passive RF tags.

Example 3. The system of Example 1, wherein the plurality of asset tags comprises active tags.

Example 4. The system of Example 1, wherein the plurality of asset tags comprises tags with visual identifiers and the plurality of detector stations comprise a plurality of cameras for reading the visual identifiers.

Example 5. The system of Examples 1 or 2, wherein adjacent members of the plurality of detector stations form a mesh network.

Other hardware and processing steps may be used to monitor animals. The systems involved may do statistical analysis on different types of data (e.g., drinking pattern, eating patterns, movement, environmental data, etc.) and correlate that data to get a measure of healthiness of a particular animal or heard or some subset. The health may be represented by a number: a wellness score or health score. The wellness score can be derived from behavior of the animal and the conditions of the environment. The system may aggregate these and considers the animal or herd's overall wellbeing.

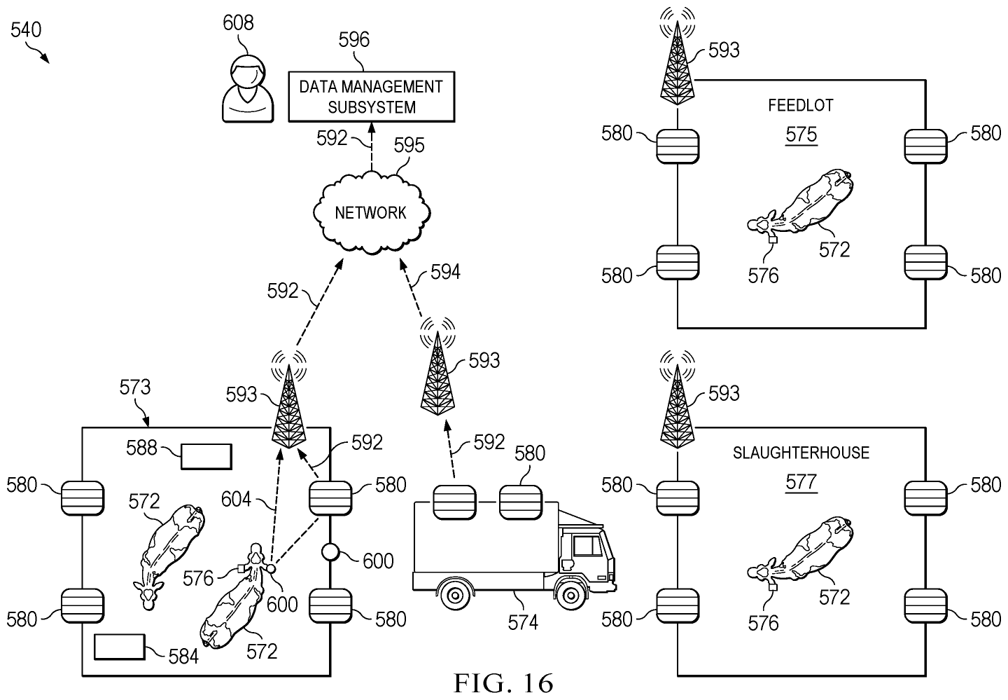

Referring now primarily to FIG. 15, an animal management system 540 for monitoring a plurality of animals (e.g., 120 in FIGS. 1 and 572 in FIG. 16) is presented. The animal management system 540 includes an asset management subsystem 544, which includes a data management subsystem 548. The data management subsystem 548 includes at least one data management memory 552, which may be a non-volatile memory, and an associated data management processor 556.

The system 540 further includes an animal data acquisition subsystem 560, which may be any or a combination of the types of systems previously presented in connection with FIGS. 1-14 or others below. The system 540 also includes an environmental data acquisition subsystem 564. The data from the animal data acquisition subsystem 560 and the environmental data acquisition subsystem 564 may be transmitted by a communication link 568 to the asset management subsystem 544 by any known means, e.g., hard-wired connections such as I2C, SPI, UART, USB, Ethernet and fiber optic links, or wireless communication including Bluetooth, Zigbee, LoRaWAN, WiFi, cellular and satellite. The communication link between the data acquisition subsystem and the asset management subsystem may be a direct connection or involve a plurality of transmitters and receivers, gateways, switches, routers, and other intermediate communication nodes.

In some embodiments of the system 540, the data-management memory 552 and data-management processor 556 may perform the following programmed steps: receiving and storing data from the animal data acquisition subsystem 560, receiving and storing the environmental data from the environmental data acquisition subsystem 564, and using the received data to produce a current wellness score indicative of a member of the plurality of animals' health or indicative of the plurality of animals' health, i.e., the group or herd. Moreover, current wellness scores may be statistically analyzed or manipulated to arrive at wellness score for a period of time, e.g., a day, a week, a month, a lifetime (or all existing data).

Referring now primarily to FIGS. 15 and 16, an illustrative embodiment of an animal management system 540 for monitoring a plurality of animals 572 over time is presented. The animals 572 may be monitored in pastures 573, transports (e.g., trucks) 574, feedlots 575, slaughterhouse 577, or other locations. In other words, the animals 572 may be monitored at the locations where they spend any meaningful time or event-prone locations during their lifetimes.

The system 540 includes an animal data acquisition subsystem 560 that includes a plurality of RF asset tags 576 or sensors attached to the plurality of animals, wherein each of the plurality of RF asset tags 576 includes a non-volatile memory (see 132 in FIG. 2) having a unique identifier code that can be transmitted by a transmit circuitry (see 136 in FIG. 2) when the RF asset tag 576 is energized by a radio signal.

The system 540 also includes a plurality of RF detector stations 580 (see also FIG. 3). At least one of the plurality of RF detector stations 580 is positioned at least within 5 meters of at least one water trough 584, and at least one of the plurality of RF detector stations 580 is positioned within 5 meters of at least one feed trough 588. In other embodiments, the troughs may be within at least 3 meters. Each RF detector 580 is configured to transmit a radio signal to any of the plurality of RF asset tags 576 within a detection zone or field (see, e.g., 215 in FIG. 5) for that RF detector 580 and receive a returned signal with the unique identifier code. Each of the plurality of RF detectors 580 has a detector-station processor and a detector-station memory, which is a non-transitory memory, for executing programmed code.

The system 540 includes one or more communication links 592 for transmitting signals from the plurality of RF detector stations to a data management subsystem 596. The communication links 592 may take many forms including radio transmitters and receivers, gateways 593, back haul links 594, networks 595, wired couplings, RF links, and other devices and means as those skilled in the art would appreciate, including, for example, hard-wired connections such as I2C, SPI, UART, USB, Ethernet and fiber optic links, or wireless communication including Bluetooth, Zigbee, LoRaWAN, WiFi, cellular and satellite. The communication link may be a direct connection or involve a plurality of transmitters and receivers, gateways, switches, routers, and other intermediate communication nodes. The gateway 593 is getting data from sensors 600 and detectors 580 and transmits to the data network 595, which delivers it to the data management system 596. The gateway 593 may just be a conduit for transmitting data like a DSL modem—that is a kind of gateway—and it could be something else. The gateway 593 may also do some aggregation, correlation, or statistical processing at the field site and then send conclusions versus just raw data. This type of analysis and aggregation may occur at the detectors 580 and sensors 600. In some embodiments, the gateway 593 includes a processor and associated non-transitory memory to do certain algorithms there.

The data management subsystem 596 includes one or more management processors and management memories. Each of the one or more management memories is a non-transitory memory. Each of the plurality RF detector stations 580 includes the detector-station processor and the detector-station memory that may be programed to receive a returned signal with the unique identifier code from any RF asset tags 576 in its detection zone and transmit the unique identifier code using the communication link 592 to the data management subsystem 596.

In some embodiments, the detector-station memory includes stored instructions, which when executed by the detector-station processor, cause the detector-station processor to only transmit detections of RF asset tag detections above a detection threshold for a given time period. Adjacent members of the plurality of RF detector stations 580 may communicate with one another and only send one signal with data over the communication link 592 to the data management subsystem 596 to save energy for one of the adjacent members. See FIG. 8.

Each of the plurality of RF detector stations 580 may include a synchronization clock, and the plurality of RF detector stations 580 may be programmed to transmit at unique times to avoid interference.

The system 540 may also include an environmental data acquisition subsystem 564 for transmitting information on the environment in which the animals 572 have been. In one embodiment, the environmental data acquisition subsystem 564 includes one or more sensors 600 for detecting an attribute of an environment. The sensors 600 may in some embodiments be on the animals 572 or in proximity to them. The sensors 600 may detect temperature, noise levels, humidity, water temperature in trough 584, air quality, or other environmental data. In some embodiments, the sensor 600 may be an accelerometer placed on the animal. The sensors 600 include at least one transmitter coupled (including formed as an aspect) to the one or more sensors 600 for transmitting data from the one or more sensors 600 to the data management system 596 as suggested by 604 and the communication link 592.

In some embodiments, a data management system 596 includes a data-management-system processor and a data-management-system memory programmed to execute the following steps: store received data from the animal data acquisition subsystem and the environment data acquisition system in a database, determine and store a current wellness score for each animal or a group of animals from the received data, and using the current wellness score for a period of time to determine a period wellness score for each animal or a group of animals. These steps and approaches are further described in connection with forthcoming figures.

A user 608 may interact with the data management system 596. Data from all the animals 572—sensors 600 on or near them and detectors 580—is funneled back over data network or communication link 592 to a centralized data application, the data management system 596, which may include a database, software (back end analytics, statistical analysis algorithms), and a user interface. The user 608 can log in and check the overall wellness of one or more animals 572. For example, the user 608 may want to know if there are there any animals with a low wellness score? If so, the user can analyze in more detail a particular animal not doing well. The user 608 can login and check or certain alarms may be programmed in to give notices if certain parameters are off, e.g., outside of thresholds. The user 608 may login in for information or input or may receive a push notification.

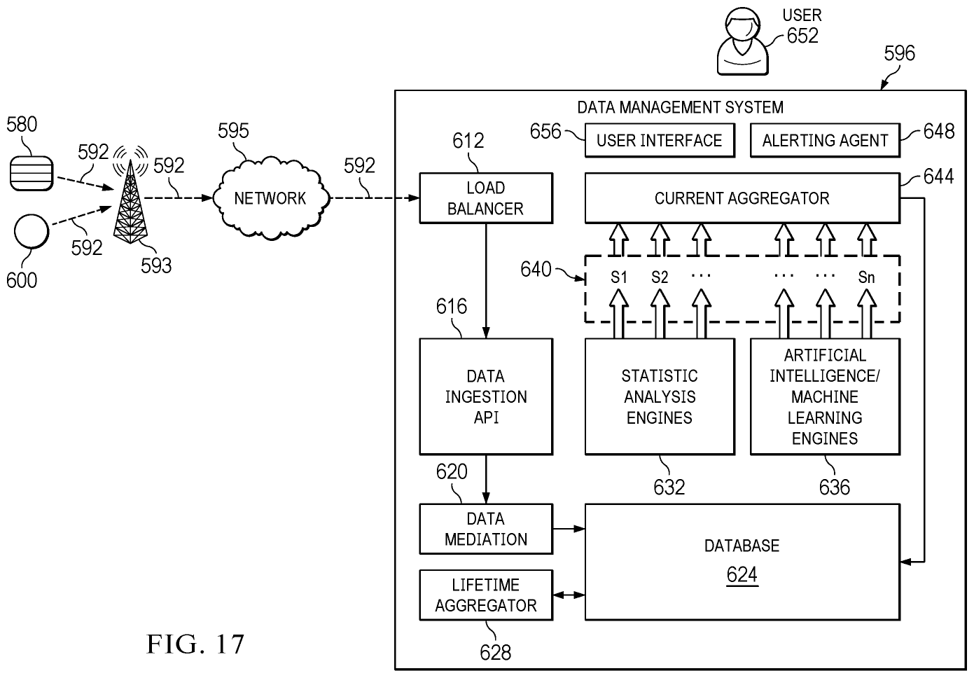

Referring now primarily to FIG. 17, an illustrative embodiment of a data management system 596, or subsystem, is presented. The data management system 596 is part of a larger animal management system as shown in FIG. 16. To the left (for orientation shown in figure) are a number of components from FIG. 16 showing from where data is coming. The detectors 580 and sensors 600 send data over a communication link 592 including a gateway 593 and a data network 595 to the data management system 596.

As the data arrives at the data management system 596, the data goes into a load balancer 612 that distributes the data to any one of many instances of the data ingestion API 616. The purpose of the load balancer is to ensure that data processing is distributed among a plurality of available data ingestion API instances to achieve high-availability, and to allow the system to scale and be able to process large amounts of inbound API requests. The data ingestion API performs preliminary processing of the data to authenticate the sender, validate that the data conforms to expected syntax, format and ranges, and provide API security functions including authentication, authorization, data validation, rate limiting, threat detection and prevention. From the data ingestion API 616 the data or portions may go to a data mediation unit 620. The data mediation unit is responsible for normalizing the data received by a plurality of APIs and converting the data into a common format that can be stored in a database. From the data mediation unit 620, data or aspects of the data goes to a database 624.

Various modules pull and supply data to the database 624. A period aggregator, or lifetime aggregator 628 accesses data from the database 624 to make lifetime deductions, or period deductions, about the wellness of an animal or herd/group. Other analytical engines or modules, e.g., statistical analysis engine 632 and artificial intelligence (AI)/machine learning (ML) engine 636 also pulls and saves information from and in the database 624. The AI/ML engine 636 calculates different aspects of wellness depending on what type of data is being analyzed, e.g., has the animal or herd been feeding well. The data flow is typically two ways with the database 624. In addition to pulling input data, the outcomes (outcome data) of the algorithms in the lifetime aggregator 628, statistical analysis engines 632, and AI/ML engine 636 are also stored back in the database 624. The outcome data can be looked up later. The resultant wellness scores are symbolically shown at 640.

The data management system 596 may include different statistical analysis engines and AI/ML engines because each looks at a different aspects. One is looking at what is the wellness of the animal if one is only looking at the animal (or herds′) drinking behavior. Another is considering the wellness of the animal (or herd) if one is only looking at temperature and noise. Those skilled in the art will appreciate that many different wellness sub-scores for different categories of environmental conditions or animal behaviors may be determined. The data management system 596 combines all of those or a desired number of them into a single wellness score. For example, the overall wellness of a particular animal may be given as “75” or some number. A current aggregator 644 is the module running an algorithm that does the combining of sub-wellness scores; the current aggregator 644 takes multiple sub-scores and comes up with a single score. The outcomes of the current aggregator 644 go to the database 624 and an alerting agent 648.

The alerting agent 648 monitors for wellness scores or sub-scores that are outside of the threshold ranges and provides an alert if certain conditions are met. If the alerting agent 648 determines that a monitored wellness score or sub-score is outside of the threshold, the alerting agent 648 will contact the user 652 in one of a number ways, e.g., SMS message or email or phone call playing a message or other communication. A user interface 656 may be accessed by the user 652 to check or do requests. The thresholds of the alerting agent 648 may be determined by an engine 632 or 636, such as send an alert if an animal is more than 25% below the average drinking time for a given period. The threshold may also be set in the system based on scientific data or the advice of a veterinarian, e.g., if an animal moves less than x feet over a period, send an alert. Many different thresholds may be set. In some embodiments, the alerting engine 648 may require multiple sub-scores to be off thresholds to send an alert.

The current aggregator 644 takes all the sub wellness scores to come up with an overall current wellness score. The lifetime aggregator 628 may take the wellness scores saved in the database 624 by the current aggregator 644 and come up with a period wellness score, or meta-wellness score or lifetime wellness score. In other words, the lifetime aggregator 628 calculates wellness for a longer period, such as the whole recorded life of the animal in the system 596. The current aggregator 644 can have the period defined, e.g., daily in one embodiment or weekly.

At any given time, the user 652 can log in through interface 652, which may be remote access or a physical access, and see wellness scores and see the data by day or other period. A chart of the current wellness scores or sub-scores may be presented to graphically show ups and down. Such information allows the user to take action instantaneously to address situations. For example, if the wellness score is low for all the animals, someone can see that the reason is that the drinking sub-score for the animals is considerable off the standard by a considerable amount and then someone can look at the water trough there or try to figure out what is happening. In contrast, the lifetime aggregator 628 combines those daily scores or some other shorter period scores to arrive at a lifetime (or longer period) score so that one can evaluate the animal or herd from a market perspective or comparative basis. For example, one might learn that last year on average the animals had a wellness score on average of 20 but this year the average is better by 10. Why did it change? One can look at the macroscopic. Also, one may use the lifetime score for consumers to have provable evidence that the animal was well cared for. For example, in one embodiment, a meat package may have a QR or bar code that when scanned pulls up the lifetime wellness score of the animal to show it was treated well or to provide other information.

The data management system 548 with non-volatile memory 552 and processor 556, can do many different operations on the data to facilitate monitoring and assisting with the wellness of animals. It should be noted that the various operations in other embodiments may be performed by other memory-processors in the system, e.g., some may be done in the animal data acquisition subsystem 560, at a gateway 593, or by an environmental data acquisition subsystem 564 as those skilled in the art will appreciate.

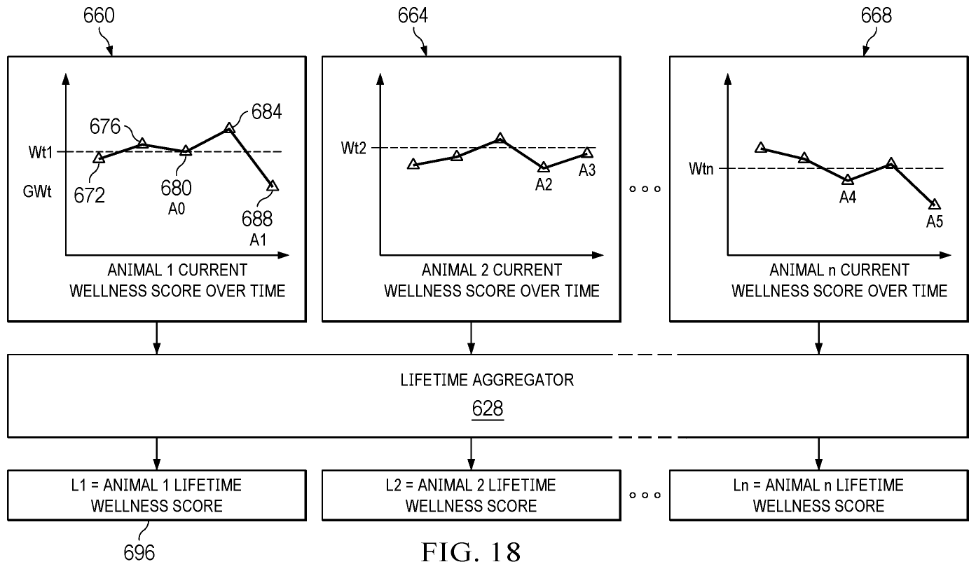

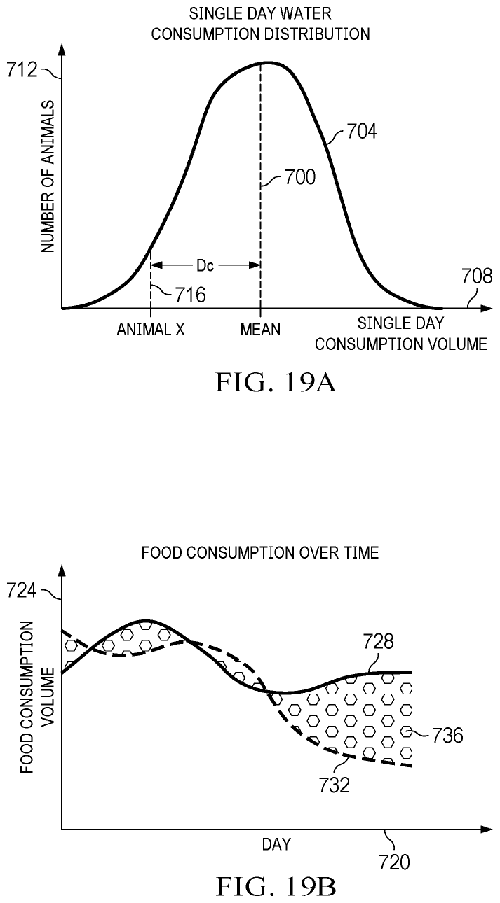

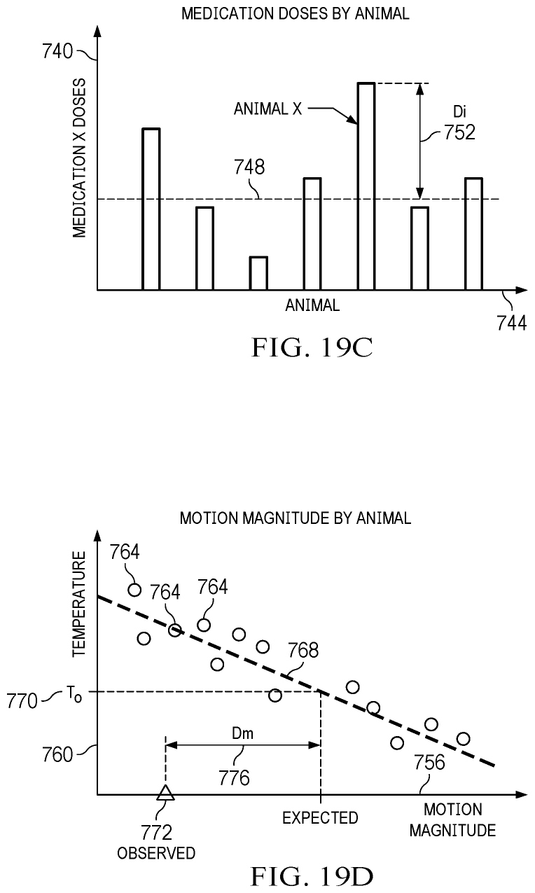

Referring now primarily to FIG. 18, a number of examples statistical processes that may be used by the lifetime aggregator 628 are presented. Each animal has a wellness score that varies over time. Data for animal one is shown at 660. Data for animal two is shown at 664. Data for animal n is shown at 668. The data, which is current wellness scores, for animal one has data points 672, 676, 680, 684, and 688, and a weighted average WO or resultant number from processing that represents wellness over the longer period involved, i.e., the lifetime wellness score. The process is the same for the other animals' data 664, 668. As suggested by representative FIGS. 19A-19D, a number of different types of analysis may be done to arrive at the lifetime wellness score.

Referring now primarily to FIGS. 19A-D, each one gives an example of how data might be processed depending on the type of data that one receives. Different type of statistical analyses or different algorithms may be used to determine meaningful deductions from that data. FIGS. 19A-D show how one may use different interpretations of the data values provided to derive a wellness score based on that information.

FIG. 19A presents a deviation from the mean approach. In this example, the data is for water consumption. This data may be for a particular animal or for the heard. For example, consider that there are two herds involving two different pens for holding the animals. One pen might be shaded because it is close to trees. The other might be in sunlight and the animals get hotter and thirstier in that one. The animals in the shady pen might drink less than the pen with sunlight. Accordingly, when one does this analysis, one wants to look at animals in similar conditions and then calculate the average or mean water consumption on a particular day. That produces the mean shown by dotted line 700. The bell curve 704 is the distribution of water consumption by the different animals. On the abscissa 708, or horizontal axis, is the amount of water, and the ordinate, or vertical axis 712, is how many animals had that much water. The representative line 716 hits the curve 704 and shows on the ordinate how many animals drank the water volume at line 716 on that day. The line Dc shows the distance from the mean 700. The further from the mean 700, the lower an animal or herd's wellness score is going to be because it or they are dirking a lot more or lot less water.

Representative FIG. 19B depicts data for food consumption and shows another example of weighting. For food consumption one wants to consider what happened over a period of time. The abscissa, or x axis 720, presents time in days and the ordinate, or y axis 724, presents food consumption volume. The line 728 represents an average for all animals over the time period. The other line 732 presents how much was consumed by one particular animal being considered. The shaded area 736 is the difference. In an ideal situation, any particular animal would behave fairly identical to the herd and the shade area 736 would be close to zero. The more the behavior of an animal varies, the larger the shaded area is. The analysis may consider the area difference 736 for the time series chart to arrive at a wellness score.

Referring now to the representative FIG. 19C, data on medication given to the animals is presented. The data is just a raw count. The ordinate, or y axis 740, is the number of doses given and the abscissa, or x axis 744, are numbers representing different animals. The prescribed or threshold dose given is shown by line 748, and a difference between it and any particular animal is shown as distance 752, Di. The greater distance 752 an animal is from the threshold 748, the lower the wellness score. That threshold 748 could be something calculated algorithmically based on averages for the herd or something set as a goal by the veterinarian.

Referring now primarily to the representative FIG. 19D, data on motion of the animals is presented. This example is given to show a case in which linear regression may be desirable. Linear regression may be used to plot two different features, e.g., the amount of motion on the ordinate, or x axis 756, versus temperature on the ordinate, or y axis 760. As one would expect, the animals move less when it gets hotter. The data 764 is plotted and a linear regression line 768 is produced that shows the expected motion for temperature. If one sees a particular animal at a time at which the temperature is Tₒ 770 that has level of motion as depicted at 772 (observed motion for particular temp) the difference may be expressed as distance Dm 776 and one would suspect that there is an issue with that animal. That animal receives a lower wellness score.

In addition to the statistical analysis approaches suggested in different situations in FIGS. 19A-D, artificial intelligence (AI) and machine learning (ML) may be used to further enhance the data analysis.

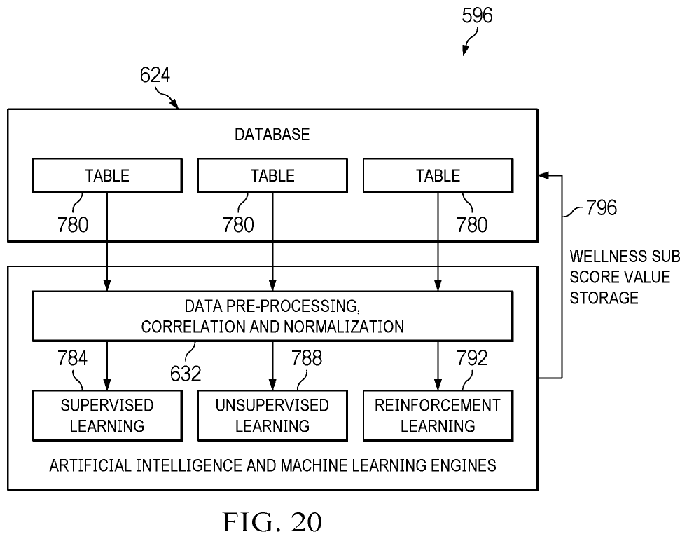

Referring now to FIG. 20, a portion of a data management system 596 is presented that includes AI/ML. The data may be loaded in database 624 such is represented in tables 780. An analytical engine or statistical engine 632 may develop certain information from the data. The data may be used by one of three types of AI/ML engines, e.g., supervised learning 784, unsupervised learning 788, or reinforcement learning 792. Which one is used comes down to the level of independence and whether it needs training data or tries to come up with deductions on its own. A wellness sub-score may be determined and saved back in the database 624 as suggested by line 796.

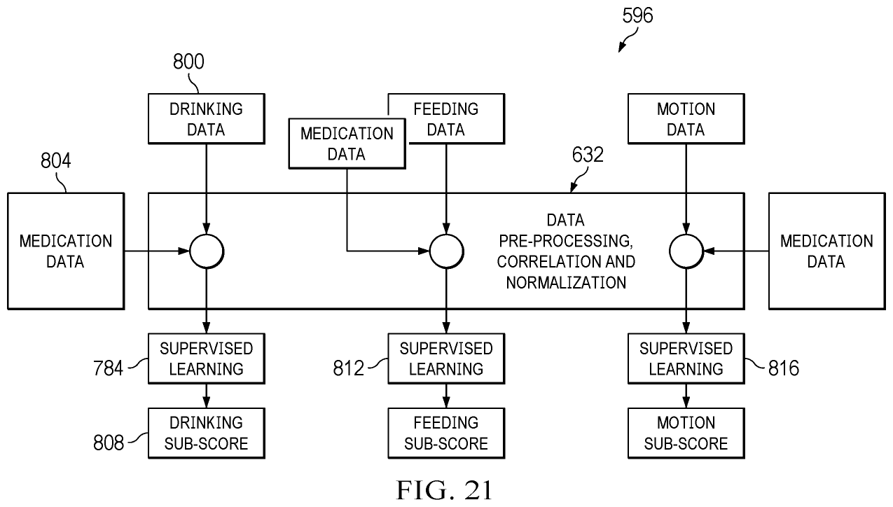

Referring now primarily to FIG. 21, another aspect of the data management system 596 is shown. This figure is similar to that of FIG. 20, but emphasizes that certain types of data are better suited for different types of AI/ML. For example, drinking data 800 and medication data 804 are better suited for a supervised learning type AI/ML engine 784 to produce a drinking sub-score or sub-wellness score 808. The other two AI/ML engines 812, 816 are labeled as supervised learning but might be unsupervised learning or reinforcement learning.

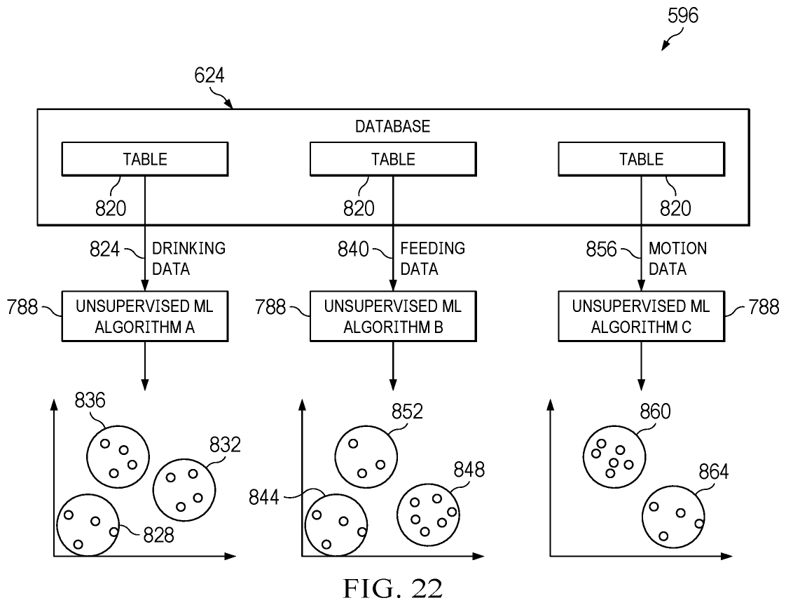

Referring now primarily to FIG. 22, a portion of a data management system 596 is presented that is similar to that in FIG. 21 except unsupervised ML is used by the AI/ML engines 788. Unsupervised learning is often used for classification purposes. The engines 788 may be used to classify the animals into, for example, high, medium, or low drinkers, feeders, or movers.

The unsupervised learning engines 788 are used to generate a plurality of wellness sub-scores. The input data is stored in a plurality of tables 820 in the database 624 that is provided to the unsupervised AI/ML engines 788 to produce wellness sub-scores by classification. In one illustrative embodiment, drinking data 824 may be processed by an unsupervised AI/ML engine 788 to produce a plurality of classifications as illustrated by class classes 828, 832, 836 and to assign a wellness sub-score to each class. Likewise, feeding data 840 may be processed by an unsupervised AI/ML engine 788 to produce a plurality of classifications as illustrated by classes 844, 848, 852 and to assign a wellness sub-score to each class. In a similar manner, motion data 856 may be processed by an unsupervised AI/ML engine 788 to produce a plurality of classifications as illustrated by classes 860, 864 and to assign a wellness sub-score to each class. Other types of information (e.g., air quality, temperature, humidity, proximity or socialization with other animals, noise levels, etc.) may be processed by additional unsupervised AI/ML engines to produce additional classifications and wellness sub-scores.

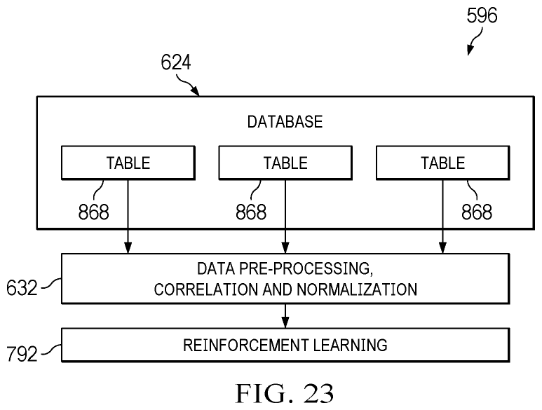

Referring now primarily to FIG. 23, a portion of another illustrative embodiment of a data management system 596 is presented. Data shown in tables 868 stored in database 624 is provided to the data pre-processing, correlation and normalization module 632. From there processed data is delivered to a reinforcement learning AI/ML engine 792. The reinforcement learning AI/ML engine 792 is used to generate a plurality of wellness sub-scores. The different types of data, such as drinking, feeding, motion, and other available information may be used as factors by the reinforcement learning algorithms 792 with the algorithm learning agent tasked with finding the optimal policy for the factors.

With this approach, feedback is given to the engine 792 to guide the algorithm to make better assessments of wellness. For example, if the engine 792 is giving poor wellness scores but those animals were taken out and inspected or examined by a veterinarian, and the veterinarian indicated that actually this animal is good, the engine 792 is given feedback do something different the next time those conditions exist.

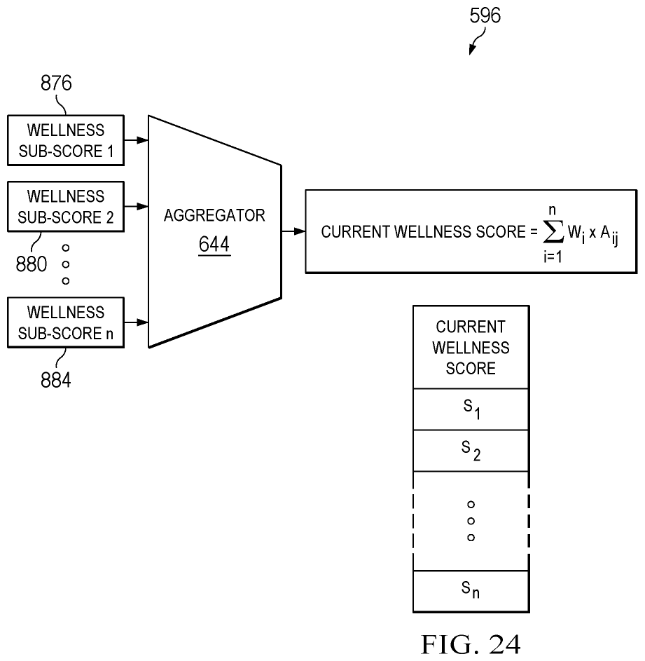

Referring now primarily to FIG. 24, an example of a portion of a data management system is presented with focus on the aggregator 644 (see also FIG. 17). The left side is the aggregator 644 with various illustrative wellness sub-scores 876, 880, 884 coming in from the engines 632, 636 (FIG. 17). The aggregator 644 may, in some embodiments, sum data but with different weights assigned to different data types. The data is put in a matrix and assigned different weights. For example, based on experience, it may be that drinking is a better indicator of wellness than feeding and drinking may be weighted more heavily. It is not just raw summation but weighting. This is indicated in following illustrative table.

TABLE 2

| | | | | | Current |
|---|---|---|---|---|---|
| | | | | | Wellness |
| | Sub-score 1 | Sub-score 2 | . . . | Sub-score n | Score |
| Weight | W₁ | W₂ | . . . | Wₙ | — |
| Animal 1 | A_{1, 1} | A_{1, 2} | . . . | A_{1, n} | S₁ |
| Animal 2 | A2, 1 | A_{2, 2} | . . . | A2, n | S₂ |
| . . . | . . . | . . . | . . . | . . . | . . . |
| Animal j | Aj, 1 | | | A_{j, n} | Sₙ |

Using a weighted sum approach in the calculation of the current wellness score 905 for each animal is one of many possible options. Other embodiments may use other approaches, including using the minimum wellness sub-score, the maximum wellness sub-score or the average of the wellness sub-scores.

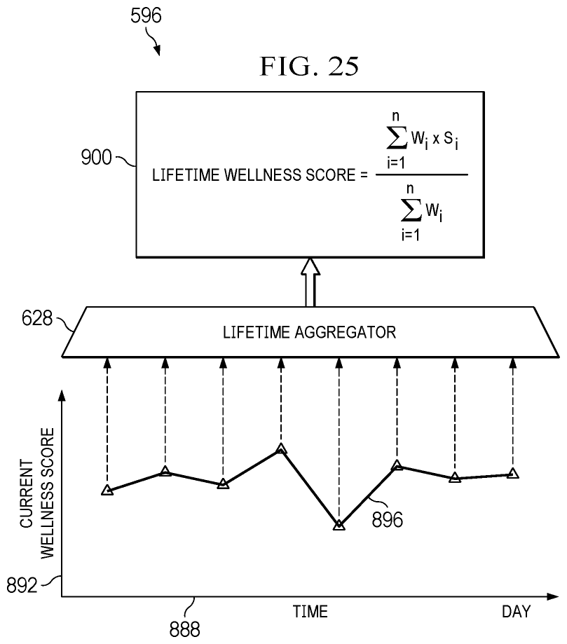

Referring now primarily to FIG. 25, a portion of a data management system 596 is shown that features the lifetime aggregator 628 (see also, FIG. 2). Current wellness scores developed by the current aggregator 64 (FIG. 2) may be used to arrive at a lifetime or period wellness score. The current wellness scores for an animal may be plotted over the entire time and the plot used to determine the overall wellness score for the period involved. Thus, for example, the graph at the bottom has time on the abscissa, or x axis 888, and the current wellness scores on the ordinate, or y axis 892. The resultant data plot 896 shows the wellness over time. The lifetime aggregator 628 may use one of many different data analysis or statistical analysis approaches to arrive at the lifetime wellness score 900 as suggested by the summation formula in the figure.

The weighting of the current wellness scores may help produce more accurate indications. For example, one might expect an animal to be less healthy when it first enters into the monitored system and so weighting the current wellness scores more heavily after an initial adjustment period may provide a better result.

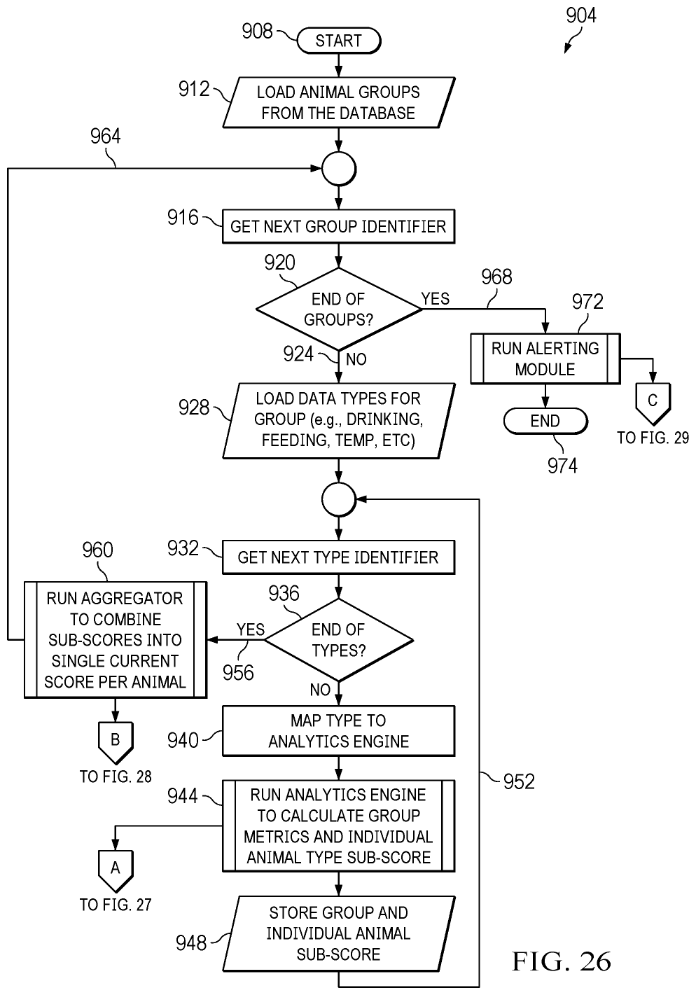

Referring now primarily to FIGS. 26-29 a number of illustrative process flows are given for different aspects of implementing the data management system 596 of an animal management system 540 (see, e.g., FIG. 16). Those skilled in the art will appreciate that many other steps and approaches may be used.

Referring now primarily to FIG. 26, an illustrative process 904 is presented for obtaining the current wellness sub-score for a plurality of animals. Note that herd behavior may be used as a comparative feature for particular animals. Whether an animal is drinking a lot or not on its own may not mean much, but may when compared to other animals in the herd under at least approximately the same conditions. Accordingly, the process 904 may involve calculating a group metric as well as scoring the particular animals.

The process starts at 908 and data from the database concerning the different groups of animals is loaded at step 912. Groups can be anything. For example, it could be grouping by pen. Animals may be grouped by 50 or 100 or another number at a time in individual pens. In this example that is what a group is.

The list of the groups is loaded 912. The group identifier is obtained at step 916. The process 904 is looking for the end of the groups at interrogatory 920. Until the end is reached, the process continues on the negative path 924 to step 928 where the data types for the group are loaded (e.g., drinking, feeding, temperature, etc.). Only some of the data may be loaded for that particular group. The process iterates over the different types of data starting at 932. In this example, three types were mentioned as examples: drinking, feeding, and temperature. Each of those will be processed over steps: 932, 940, 944, 948, and 952.

At step 932, the type identifier, e.g., drinking, is obtained. Interrogatory 936 asks if all the types have been considered. If not, the process continues to invoke the analytics engine that is appropriate at step 940 and that engine is run at step 944. The output for the plurality of animals and the individual animal is stored at 948. The process then proceeds on path 952 and returns to step 932. This iteration continues until all the types are completed.

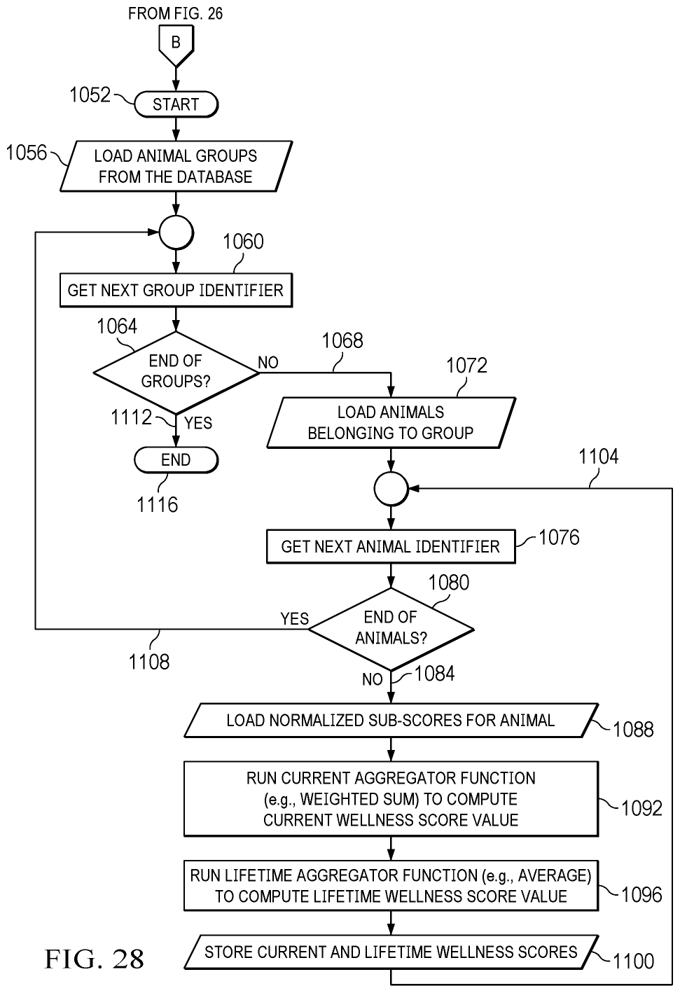

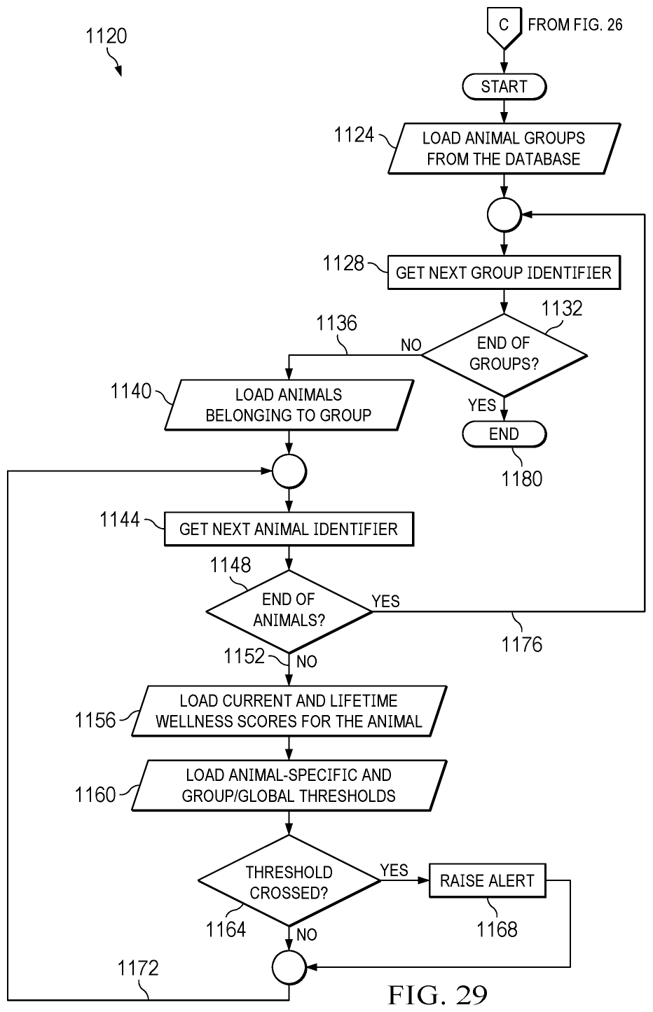

When the process gets to the end of types the answer to interrogatory 936 becomes positive and the process continues on path 956. That leads to step 960 where the data is aggregated into a single current score. That determination is detailed in another example shown in FIG. 28. Once the aggregator combines the sub-scores into a single current wellness score at step 960 and stores it in the database, the process continues on path 964 back to step 916. The process continues until the end of groups is reached and interrogatory 920 becomes positive. Then, the process continues on path 968 to step 972, which runs an alert module as illustrated in FIG. 29. The alert module is looking to see if any of the scores are outside of acceptable limits so as to warrant an alert being sent. The process ends at 974.

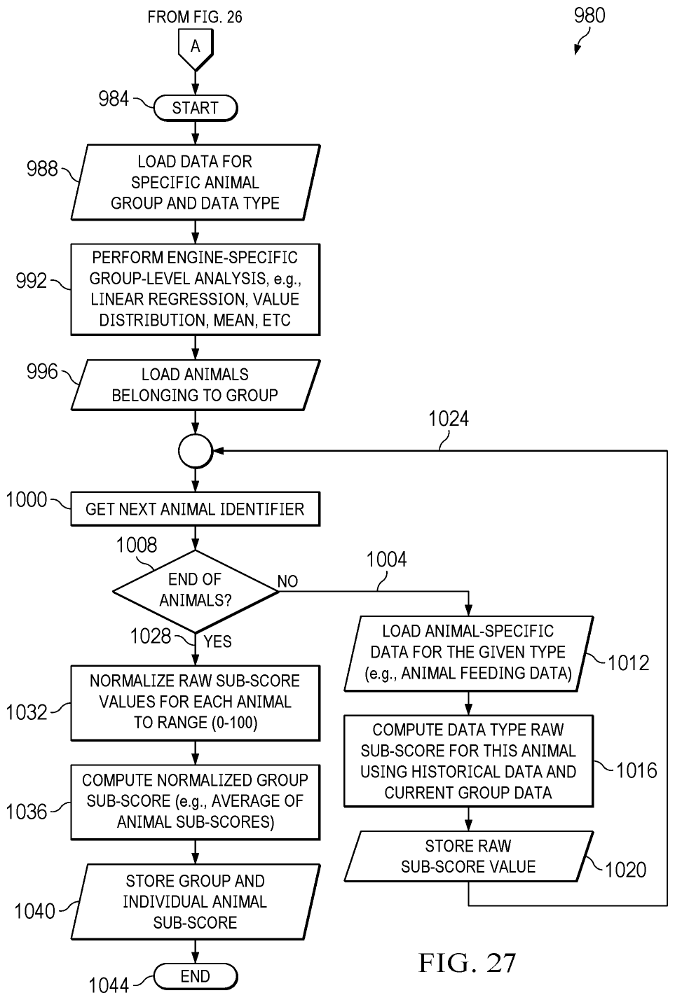

Referring now primarily to FIG. 27, a process flow 980 is presented that is the running of the analytics engine as referenced in step 944 in FIG. 26 (see also 632 in FIG. 17). The process 980 starts at 984 and then the data for a specific animal group is loaded along with the data type at 988. For example, this step may involve loading from the database all the drinking values for all the animals in pen 5. Then, depending on the type, the system runs different types of statistical analysis: linear regression, value distribution, deviation from the mean etc. This analysis is at step 992. This will develop the group data that is used for comparisons and other uses for the group. Step 992 calculates the behavior of the group. For example the system may have all the drinking behavior of the animals in pen 5 and calculates an average for that group. It prepares the group level behavior.

Then, data on animals belonging to the group are loaded at step 996 as the next data input. This is loading a list of all the animals in the group. For each animal, the system wants to see how it behaved compared to the result that was calculated at 992. The next animal is loaded at step 1000. The process 980 will keep going on path 1004 until the end of animals is detected at interrogatory 1008. The process 980 keeps loading until it hits the end of the animals in the file.

On path 1004, the process 980 loads the particular data, or animal-specific data, for the type at step 1012. The process 980 then computes a sub-score using historical data at step 1016. For example, the drinking data for cow 6 may be considered and the historical data for that cow is provided and with the group data the system can compute a sub-score for drinking for cow six. That sub-score is saved at step 1020. The process 980 then goes back along path 1024 and does the same for another animal until the end of animals is hit.

Once the end of animals is reached, interrogatory 1008 become affirmative, and the process continues on path 1028. At step 1032, the raw sub-scores are normalized. For example, normalizing of the drinking volumes considers more data. Drinking too much water is not as bad as not drinking enough, and a normalizing factor may be applied to flatten the bell curve on the right side (the drinking more than norm side) to bring it closer to the main. It is an adjustment step.

The process then continues to step 1036 in which the wellness score of the group may be determined. The individual wellness scores may be used to arrive at a wellness score for the group. The system can normalize the collection of sub-scores for the animals for that group, do the average, and analyze the data to do things like deviation from the mean. It gives group level wellness scores that can help one figure out why animals in Group 5 are doing better than animals in Group six and the like. At step 1040 (see as 948 in FIG. 26), the process stores the group and individual animal sub-scores and then ends at 1044 and returns to path 952 (FIG. 26).

Referring now primarily to FIG. 28, a process for running an aggregator to combine sub-scores into a single current wellness score is presented (see 960 in FIG. 26). The process starts at step 1052 and the animal groups are loaded from the database at step 1056. The system gets a list of all the groups or pens. At step 1060, the system gets the group identifier. At interrogatory 1064, the process considers whether the end of the groups has been reached. If not, the process continues on path 1068 to load the normalized sub-scores at 1072 for the group. Then an identifier on a particular animals is obtained at step 1076. Interrogatory 1080 consider whether the end of the animals has been reached. If not, the process continues on path 1084.

Continuing to step 1088, the process calls for all the sub-scores that were calculated for that particular animal, e.g., drinking, eating, temperature, etc. With that data, at step 1092, the current aggregator determines a wellness score based on the sub-scores (and any environmental data provided by an another step). For example, in one embodiment, a weighted sum is used to create an overall current wellness score based on all the sub-scores.

The additional current wellness score needs to be factored into the lifetime wellness score. This can either be done later, i.e., do the calculation once the lifetime wellness score has been requested, or the process can have a running tally and adjust it every time it gets another current wellness score. In this illustrative embodiment, the process is using the tally method so that the lifetime wellness score is always on hand. Thus, the next step 1096 calculates the lifetime wellness score and then at step 1100 updates the current and lifetime wellness scores. The process then goes along path 1104 back to the next animal. When the final animal has been considered, the end of animals is reached and the interrogatory 1080 becomes positive moving the process along path 1108.

That leads to step 1060 to get the next group identifier. When the end of groups is reached, interrogatory 1064 becomes positive and that leads the process along path 1112 to the end 1116.

Referring now primarily to FIG. 29, a process 1120 for running an alert module 972 (FIG. 26) is presented. The process considers whether data is beyond a threshold such that an alert needs to be sent.

There are certain thresholds that may be set such as by a veterinarian. For example, the veterinarian may say a threshold is that an animal should not get more than five shots of antibiotics over a lifetime. A threshold can also be based on the average data for the herd in some instances. In any event, thresholds are established for comparison purposes.

The process 1120 loads the list of all the groups from the database at step 1124. The process iterates this process for each group, e.g., for each pen. The group identifier is obtained at step 1128. The process then goes interrogatory 1132 where it asks if the end of the groups has been reached. If not, the process flow goes down the negative branch 1136 and then loads the animals and data belonging to the group at step 1140. Then consideration of each animal beings.

At step 1144, the process gets the animal identifier for a particular animal. The process keeps looking for each animal. If it's not the end of the animals as asked at interrogatory 1148, the process goes down the path 1152. That leads step 1156, which involves reading the current wellness score and the lifetime wellness score for the animal. Then the thresholds or the animal specific group global thresholds are loaded at 1160.

The process 1120 then considers at the interrogatory box 1164 whether the threshold has been crossed for the particular animal under consideration. If yes, an alert is raised at step 1168 before the process continues to path 1172. If not, the process continues to path 1172. A threshold can be set for a particular animal or for the overall group. The alert raised at step 1168 may be an audible alert, SMS, phone call, mobile push notification, an email, an on-screen alert, or any other kind of alert to the user.

The process iterates for each animal until it reaches the end of the animals. That makes the interrogatory 1148 become affirmative, and the process continues on path 1176 to consider another group. When the final group is considered, interrogatory 1132 becomes positive, and the process ends at 1180.

In some embodiments, for all the processes, when the animal data is obtained, the process may also pull environmental data from the environmental data acquisition subsystem associated with the animal or herd during the relevant time under consideration. This may impact the wellness score. For example, if the temperature has been unusually high, the wellness score may be lower.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed:

1. An animal management system for monitoring a plurality of animals over time, the system comprising:
an animal data acquisition subsystem comprising:
a plurality of RF asset tags attached to the plurality of animals, wherein each of the plurality of RF asset tags comprises a non-volatile memory having a unique identifier code that can be transmitted when the RF asset tag is energized by a radio signal,
a plurality of RF detector stations, wherein at least one of the plurality of RF detector stations is positioned at least within 3 meters of at least one water trough and wherein at least one of the plurality of RF detector stations is positioned within 3 meters of at least one feed trough, wherein the RF detector is configured to transmit a radio signal to any of the plurality of RF asset tags within a detection zone for that RF detector and receive a returned signal with the unique identifier code, and wherein each of the plurality of RF detectors has a detector-station processor and a detector-station memory, which is a non-transitory memory, for executing programmed code,
a communication link delivering signals from the plurality of RF detector stations to a data management subsystem,
wherein for each of the plurality RF detector stations, the detector-station processor and the detector-station memory include programming to receive a returned signal with the unique identifier code from any RF asset tags in its detection zone and transmit the unique identifier code using the communication link to the data management subsystem,
wherein the detector-station memory comprises stored instructions, which when executed by the detector-station processor, cause the detector-station processor to only transmit detections of RF asset tag detections above a detection threshold for a given time period,
wherein adjacent members of the plurality of RF detector stations communicate with one another and only send one signal with data over the communication link to the data management subsystem to save energy for one of the adjacent members, and
wherein each of the plurality of RF detector stations comprises a synchronization clock and the plurality of RF detector stations are programmed to transmit at unique times to avoid interference;
an environment data acquisition subsystem comprising:
one or more sensors for detecting an attribute of an environment, and
a transmitter coupled to the one or more sensors for transmitting data from the one or more sensors to the data management system; and
wherein the data management subsystem comprises a data management processor and a data management memory programmed to execute the following steps:
store received data from the animal data acquisition subsystem and the environment data acquisition system in a database,
determine and store a current wellness score for each animal or a group of animals from the received data, and
using the current wellness score for a period of time, determine a period wellness score for each animal or a group of animals.

2. The system of claim 1, wherein the data management processor and a data management memory are further programmed to execute the following step: provide an alert if the current wellness score for an animal or heard is outside of a threshold value.

3. The system of claim 1, wherein the one or more sensors for detecting an attribute of an environment comprises at least one selected from a group consisting of a temperature sensor, a noise sensor, an air quality sensor, and a humidity sensor.

4. An animal management system for monitoring a plurality of animals over time, the system comprising:
an data management subsystem;
an animal data acquisition subsystem comprising:
a plurality of RF asset tags attached to each animal of the plurality of animals,
a plurality of RF detector stations for detecting a presence of members of the plurality of RF asset tags and receiving animal-specific identifiers, wherein the plurality of RF detectors is at least in part positioned proximate to water troughs and feed troughs used by the plurality of animals, and
one or more communication links for transmitting information from the plurality of RF detector stations to the data management system;
an environment data acquisition subsystem comprising one or more sensors for detecting an attribute of an environment, a transmitter for transmitting data from the one or more sensors to the data management system; and
wherein the data management subsystem comprises a data management processor and a data management memory programmed to execute the following steps:
store received data from the animal data acquisition subsystem and the environment data acquisition system in a database,
determine and store a current wellness score for each animal or a group of animals from the received data, and
use the current wellness scores to determine a period wellness score for each animal or a group of animals.

5. The system of claim 4, wherein the one or more sensors for detecting an attribute of an environment comprises at least one selected from a group consisting of a temperature sensor, an air quality sensor, a noise sensor, and a humidity sensor.

6. The system of claim 4, wherein the data management processor and a data management memory are further programmed to execute the following step: providing an alert if current wellness scores for an animal or herd is outside of a threshold value.

7. An animal management system for monitoring a plurality of animals, the system comprising:
an asset management subsystem;
a plurality of RF asset tags attached to the plurality of animals, wherein each of the plurality of RF asset tags comprises a non-volatile memory having a unique identifier code that is transmitted when the RF asset tag is energized by a radio signal;
a plurality of RF detector stations, wherein at least one of the plurality of RF detector stations is positioned at least within 3 meters of the at least one water trough and wherein at least one of the plurality of RF detector stations is positioned within 3 meters of the at least one feed trough;
a means for transmitting the unique identifiers for detected members of the plurality of animals to the asset management subsystem;
wherein the asset management subsystem comprises a management memory and a management processor, wherein the management memory is a non-volatile member; and
wherein the management memory and management processor perform the following programmed steps:
receiving and storing data from the plurality of RF detector stations, and
using the data from the plurality of RF detector stations to produce a current wellness score indicative of a member of the plurality of animals' health or indicative of the plurality of animals' health.

8. The system of claim 7, further comprising at least one environment sensor for measuring an environmental attribute in which the plurality of animals is located to produce environmental data; wherein the means for transmitting further includes a means for transmitting the environmental data to the asset management subsystem; and wherein the management memory and management processor perform the following programmed steps: receiving and storing the environmental data, and using the environmental data and the data from the plurality of RF detector stations to produce the current wellness score.

9. The system of claim 8, wherein the step of using the environmental data and the data from the plurality of RF detector stations to produce a current wellness score indicative of a member of the plurality of animals' health or indicative of the plurality of animals' health comprises calculating an optimal value for each parameter and basing wellness from deviation from the optimal value for each parameter.
